(19) United States
(12) Patent Application Publication
(10) Pub. No.: US 2022/0239360 A1
(43) Pub. Date: Jul. 28, 2022

(54) CSI OMISSION RULES FOR ENHANCED TYPE II CSI REPORTING

(71) Applicant: Telefonaktiebolaget LM Ericsson (publ), Stockholm (SE)

(72) Inventor: Sebastian Faxér, Stockholm (SE)

(21) Appl. No.: 17/608,477

(22) PCT Filed: Apr. 27, 2020
(86) PCT No.: PCT/IB2020/053930

§ 371 Date: Nov. 2, 2021

Related U.S. Application Data
(60) Provisional application No. 62/843,048, filed on May 3, 2019.

(51) Int. Cl. H04B 7/06; H04B 7/0456

(52) U.S. Cl. CPC H04B 7/0658; H04B 7/0478; H04B 7/0626

(57) ABSTRACT

Systems and methods for Channel State Information (CSI) omission for enhanced Type II CSI reporting are provided. In one embodiment, a method performed by a wireless device for CSI reporting in a cellular communications system comprises performing a CSI omission procedure to omit a deterministic portion of Uplink Control Information (UCI) for a CSI report and thereby provide a reduced-size CSI report. Performing the CSI omission procedure comprises dividing a plurality of Linear Combination (LC) coefficients into two or more CSI omission groups having associated priority levels and, based on the priority levels of the two or more CSI omission groups, omitting LC coefficients comprised in at least one of the two or more CSI omission groups from the reduced-size CSI report. The method further comprises transmitting the reduced-size CSI report. In this manner, a deterministic portion of the UCI is omitted to provide the reduced-size CSI report.

### RELATED APPLICATIONS

This application claims the benefit of provisional patent application Ser. No. 62/843,048, filed May 3, 2019, the disclosure of which is hereby incorporated herein by reference in its entirety.

### TECHNICAL FIELD

The present disclosure relates to Channel State Information (CSI) reporting in a cellular communications system.

### BACKGROUND

### 1 Codebook-Based Precoding

Multi-antenna techniques can significantly increase the data rates and reliability of a wireless communication system. The performance is in particular improved if both the transmitter and the receiver are equipped with multiple antennas, which results in a Multiple Input Multiple Output (MIMO) communication channel. Such systems and/or related techniques are commonly referred to as MIMO.

The Third Generation Partnership Project (3GPP) New Radio (NR) standard is currently evolving with enhanced MIMO support. A core component in NR is the support of MIMO antenna deployments and MIMO related techniques such as, for instance, spatial multiplexing. The spatial multiplexing mode is aimed for high data rates in favorable channel conditions. An illustration of the spatial multiplexing operation is provided in FIG. 1. In other words, FIG. 1 illustrates a transmission structure of a precoded spatial multiplexing mode in NR.

As seen in FIG. 1, the information carrying symbol vector s is multiplied by an N_{T}× rprecoder matrix W, which serves to distribute the transmit energy in a subspace of the N_{T} (corresponding to N_{T} antenna ports) dimensional vector space. The precoder matrix is typically selected from a codebook of possible precoder matrices, and typically indicated by means of a Precoder Matrix Indicator (PMI), which specifies a unique precoder matrix in the codebook for a given number of symbol streams. The r symbols in s each correspond to a layer, and r is referred to as the transmission rank. In this way, spatial multiplexing is achieved since multiple symbols can be transmitted simultaneously over the same Time/Frequency Resource Element (TFRE). The number of symbols r is typically adapted to suit the current channel properties.

NR uses Orthogonal Frequency Division Multiplexing (OFDM) in the downlink (and Discrete Fourier Transform (DFT) precoded OFDM in the uplink), and hence the received N_{R}×1 vector yₙ for a certain TFRE on subcarrier n (or alternatively data TFRE number n) is thus modeled by

$${y}_{n} = {H}_{n} W {s}_{n} + {e}_{n}$$

where eₙ is a noise/interference vector obtained as realizations of a random process. The precoder W can be a wideband precoder, which is constant over frequency, or frequency selective.

The precoder matrix W is often chosen to match the characteristics of the N_{R}×N_{T} MIMO channel matrix Hₙ, resulting in so-called channel dependent precoding. This is also commonly referred to as closed-loop precoding and essentially strives for focusing the transmit energy into a subspace which is strong in the sense of conveying much of the transmitted energy to the User Equipment (UE).

In closed-loop precoding for the NR downlink, the UE transmits, based on channel measurements in the forward link (downlink), recommendations to the NR base station (gNB) of a suitable precoder to use. The gNB configures the UE to provide feedback according to CSI-ReportConfig and may transmit Channel State Information (CSI) Reference Signal (CSI-RS) and configure the UE to use measurements of CSI-RS to feed back recommended precoding matrices that the UE selects from a codebook. A single precoder that is supposed to cover a large bandwidth (wideband precoding) may be fed back. It may also be beneficial to match the frequency variations of the channel and instead feed back a frequency-selective precoding report, e.g. several precoders, one per subband. This is an example of the more general case of CSI feedback, which also encompasses feeding back information other than recommended precoders to assist the gNB in subsequent transmissions to the UE. Such other information may include Channel Quality Indicators (CQIs) as well as transmission Rank Indicator (RI). In NR, CSI feedback can be either wideband, where one CSI is reported for the entire channel bandwidth, or frequency-selective, where one CSI is reported for each subband, which is defined as a number of contiguous Resource Blocks (RBs) ranging between 4 to 32 Physical Resource Blocks (PRBs) depending on the Bandwidth Part (BWP) size.

Given the CSI feedback from the UE, the gNB determines the transmission parameters it wishes to use to transmit to the UE, including the precoding matrix, transmission rank, and Modulation and Coding Scheme (MCS). These transmission parameters may differ from the recommendations the UE makes. The transmission rank, and thus the number of spatially multiplexed layers, is reflected in the number of columns of the precoder W. For efficient performance, it is important that a transmission rank that matches the channel properties is selected.

### 2 Two-Dimensional (2D) Antenna Arrays

2D antenna arrays may be (partly) described by the number of antenna columns corresponding to the horizontal dimension Nₕ, the number of antenna rows corresponding to the vertical dimension Nᵥ, and the number of dimensions corresponding to different polarizations Nₚ. The total number of antennas is thus N=NₕNᵥNₚ. It should be pointed out that the concept of an antenna is non-limiting in the sense that it can refer to any virtualization (e.g., linear mapping) of the physical antenna elements. For example, pairs of physical sub-elements could be fed the same signal, and hence share the same virtualized antenna port.

An example of a 4×4 array with cross-polarized antenna elements is illustrated in FIG. 2. In other words, FIG. 2 is an illustration of a 2D antenna array of cross-polarized antenna elements (Nₚ=2), with Nₕ=4 horizontal antenna elements and Nᵥ=4 vertical antenna elements.

Precoding may be interpreted as multiplying the signal with different beamforming weights for each antenna prior to transmission. A typical approach is to tailor the precoder to the antenna form factor, i.e. taking into account Nₕ, Nᵥ, and Nₚ when designing the precoder codebook.

### 3 CSI-RSs

For CSI measurement and feedback, CSI-RSs are defined. A CSI-RS is transmitted on each transmit antenna (or antenna port) and is used by a UE to measure the downlink channel between each of the transmit antenna ports and each of its receive antenna ports. The antenna ports are also referred to as CSI-RS ports. The number of antenna ports supported in NR is any number from the set of {1, 2, 4, 8, 12, 16, 24, 32}. By measuring the received CSI-RS, a UE can estimate the channel that the CSI-RS is traversing, including the radio propagation channel and antenna gains. The CSI-RS for the above purpose is also referred to as Non-Zero Power (NZP) CSI-RS.

CSI-RS can be configured to be transmitted in certain Resource Elements (REs) in a slot and certain slots. FIG. 3 shows an example of CSI-RS REs for twelve antenna ports in NR, where 1 RE per RB per port is shown.

In addition, Interference Measurement Resource (IMR) is also defined in NR for a UE to measure interference. An IMR resource contains four REs, either four adjacent REs in frequency in the same OFDM symbol or two by two adjacent REs in both time and frequency in a slot. By measuring both the channel based on NZP CSI-RS and the interference based on an IMR, a UE can estimate the effective channel and noise plus interference to determine the CSI, i.e. rank, precoding matrix, and the channel quality.

Furthermore, a UE in NR may be configured to measure interference based on one or multiple NZP CSI-RS resources.

### 4 CSI Framework in NR

In NR, a UE can be configured with multiple CSI reporting settings and multiple CSI-RS resource settings. Each resource setting can contain multiple resource sets, and each resource set can contain up to eight CSI-RS resources. For each CSI reporting setting, a UE feeds back a CSI report.

Each CSI reporting setting contains at least the following information:
a CSI-RS resource set for channel measurement,
an IMR resource set for interference measurement,
optionally, a CSI-RS resource set for interference measurement,
time domain behavior, i.e. periodic, semi-persistent, or aperiodic reporting,
frequency granularity, i.e. wideband or subband,
CSI parameters to be reported such as RI, PMI, CQI, and CSI-RS Resource Indicator (CRI) in case of multiple CSI-RS resources in a resource set,
codebook types, i.e. type I or II, and codebook subset restriction,
measurement restriction, and
subband size, where one out of two possible subband sizes is indicated, the value range depends on the bandwidth of the BWP, and one CQI/PMI (if configured for subband reporting) is fed back per subband.

When the CSI-RS resource set in a CSI reporting setting contains multiple CSI-RS resources, one of the CSI-RS resources is selected by a UE, and a CRI is reported by the UE to indicate to the gNB about the selected CSI-RS resource in the resource set, together with RI, PMI, and CQI associated with the selected CSI-RS resource.

For aperiodic CSI reporting in NR, more than one CSI reporting settings, each with a different CSI-RS resource set for channel measurement and/or resource set for interference measurement, can be configured and triggered at the same time. In this case, multiple CSI reports are aggregated and sent from the UE to the gNB in a single Physical Uplink Shared Channel (PUSCH).

### 5 DFT-Based Precoders

A common type of precoding is to use a DFT precoder, where the precoder vector used to precode a single-layer transmission using a single-polarized Uniform Linear Array (ULA) with N antennas, is defined as:

$${w}_{1 D} ( k ) = \frac{1}{\sqrt{N}} [ \begin{matrix}{e}^{j 2 π \cdot 0 \cdot \frac{k}{QN}} \\ {e}^{j 2 π \cdot 1 \cdot \frac{k}{QN}} \\ ⋮ \\ {e}^{j 2 π \cdot ( N - 1 ) \cdot \frac{k}{QN}}\end{matrix} ] ,$$

where k=0, 1, . . . QN−1 is the precoder index and Q is an integer oversampling factor. A corresponding precoder vector for a 2D Uniform Planar Array (UPA) can be created by taking the Kronecker product of two precoder vectors as w_{2D}(k, l)=w_{1D}(k)⊗w_{1D}(l).

Extending the precoder for a dual-polarized UPA may then be provided as:

$${W}_{2 D , DP} ( k , l , ϕ ) = [ \begin{matrix}1 \\ {e}^{j ϕ}\end{matrix} ] ⊗ {w}_{2 D} ( k , l ) = [ \begin{matrix}{w}_{2 D} ( k , l ) \\ {e}^{j ϕ} {w}_{2 D} ( k , l )\end{matrix} ] = [ \begin{matrix}{W}_{2 D} ( k , l ) & 0 \\ 0 & {w}_{2 D} ( k , l )\end{matrix} ] [ \begin{matrix}1 \\ {e}^{j ϕ}\end{matrix} ] ,$$

where e^{jϕ} is a co-phasing factor that may for instance to be selected from Quadrature Phase Shift Keying (QPSK) alphabet

$$ϕ ∈ \{ 0 , \frac{π}{2} , π , \frac{3 π}{2} \} .$$

A precoder matrix W_{2D,DP} for multi-layer transmission may be created by appending columns of DFT precoder vectors as:

$${W}_{2 D , DP} = [ {w}_{2 D , DP} ( {k}_{1} , {l}_{1} , {ϕ}_{1} ) {w}_{2 D , DP} ( {k}_{2} , {l}_{2} , {ϕ}_{2} ) … {w}_{2 D , DP} ( {k}_{R} , {l}_{R} , {ϕ}_{R} ) ] ,$$

where R is the number of transmission layers, i.e. the transmission rank. In a common special case for a rank-2 DFT precoder, k₁=k₂=k and l₁=l₂=l, meaning that

$${W}_{2 D , DP} = [ \begin{matrix}{w}_{2 D , DP} ( k , l , {ϕ}_{1} ) & {w}_{2 D , DP} ( k , l , {ϕ}_{2} )\end{matrix} ] = \\ [ \begin{matrix}{w}_{2 D} ( k , l ) & 0 \\ 0 & {w}_{2 D} ( k , l )\end{matrix} ] [ \begin{matrix}1 & 1 \\ {e}^{j {ϕ}_{1}} & {e}^{j {ϕ}_{2}}\end{matrix} ] .$$

Such DFT-based precoders are used for instance in NR Type I CSI feedback.

### 6 Multi-User MIMO (MU-MIMO)

With MU-MIMO, two or more users in the same cell are co-scheduled on the same time-frequency resource. That is, two or more independent data streams are transmitted to different UEs at the same time, and the spatial domain is used to separate the respective streams. By transmitting several streams simultaneously, the capacity of the system can be increased. This, however, comes at the cost of reducing the Signal-to-Interference plus Noise Ratio (SINR) per stream, as the power must be shared between streams and the streams will cause interference to each other.

### 7 Multi-Beam (Linear Combination) Precoders

One central part of MU-MIMO is to obtain accurate CSI that enables nullforming between co-scheduled users. Therefore, support has been added in Long Term Evolution (LTE) Release 14 and NR Release 15 for codebooks that provide more detailed CSI than the traditional single DFT beam precoders. These codebooks are referred to as Advanced CSI (LTE) or Type II codebooks (NR) and can be described as a set of precoders where each precoder is created from multiple DFT beams. A multi-beam precoder may be defined as a linear combination of several DFT precoder vectors as:

$$w = {\sum }_{i} {c}_{i} \cdot {w}_{2 D , DP} ( {k}_{i} , {l}_{i} , {ϕ}_{i} ) ,$$

where {cᵢ} may be general complex coefficients. Such a multi-beam precoder may more accurately describe the UE's channel and may thus bring an additional performance benefit compared to a DFT precoder, especially for MU-MIMO where rich channel knowledge is desirable in order to perform nullforming between co-scheduled UEs.

7.1 NR Release 15

For the NR Type II codebook in Release 15, the precoding vector for each layer and subband is expressed in 3GPP Technical Specification (TS) 38.214 as:

$${W}_{{q}_{1} , {q}_{2} , {n}_{1} , {n}_{2} , {p}_{l}^{( 1 )} , {p}_{l}^{( 2 )} , {c}_{l}}^{l} = \frac{1}{\sqrt{{N}_{1} {N}_{2} {\sum }_{i = 0}^{2 L - 1} {( {p}_{l , i}^{( 1 )} {p}_{l , i}^{( 2 )} )}^{2}}} [ \begin{matrix}{\sum }_{i = 0}^{L 1} {v}_{{m}_{1}^{( i )} , {m}_{2}^{( i )}} {p}_{l , i}^{( 1 )} {p}_{l , i}^{( 2 )} {φ}_{l , i} \\ {\sum }_{i = 0}^{L 1} {v}_{{m}_{1}^{( i )} , {m}_{2}^{( i )}} {p}_{l , i + L}^{( 1 )} {p}_{l , i + L}^{( 2 )} {φ}_{l , i + L}\end{matrix} ] , l = 1 , 2 .$$

If the above formula is restructured and expressed more simply, the precoder vector w_{l,p}(k) for a certain layer l=0, 1, polarization p=0, 1 and RB k=0, . . . , N_{RB}−1 can be formed as:

$${w}_{l , p} ( k ) = \frac{1}{C} {\sum }_{i = 0}^{L - 1} {v}_{i} {p}_{l , i}^{( 1 )} {c}_{l , i} ( k ) , \\ where \\ {c}_{l , i} ( k ) = {p}_{l , i}^{( 2 )} ( ⌊ \frac{k}{S} ⌋ ) {φ}_{l , i} ( ⌊ \frac{k}{S} ⌋ ) for p = 0 and {c}_{l , i} ( k ) = {p}_{l , L + i}^{( 2 )} ( ⌊ \frac{k}{S} ⌋ ) {φ}_{l , L + i} ( ⌊ \frac{k}{S} ⌋ ) for p = 1 , \qquad$$

S is the subband size, and N_{SB} is the number of subbands in the CSI reporting bandwidth. Hence, the change in a beam coefficient across frequency c_{l,i}(k) is determined based on the 2N_{SB} parameters p_{l,i}²(0), . . . , p_{l,i}²(N_{SB}−1) and ϕ_{l,i}(0), . . . , ϕ_{l,i}(N_{SB}−1), where the subband amplitude parameter p_{l,i}² is quantized using 0-1 bit and the subband phase parameter ϕ_{l,i} is quantized using 2-3 bits, depending on codebook configuration.

7.2 Release 15 Uplink Control Information (UCI) Omission Procedure

Since there can be a large discrepancy between the PMI payload for different selection of RI by the UE for Type II CSI reporting, it is possible that the PUSCH resource allocation for carrying the CSI report does not fit the entire CSI content. For instance, the rank-2 PMI payload is almost two times the size of the rank-1 PMI payload for the Release 15 Type II codebook. Further, since the RI is dynamically selected by the UE, the gNB cannot entirely predict the PMI payload before scheduling the CSI report, and hence the resource allocation may be too small. That is, the gNB may have scheduled a resource appropriate for a rank-1 PMI report (due to, e.g., that the UE has lately been reporting RI=1) but the UE reports rank-2 PMI, which will not fit in the allocated PUSCH resource.

To remedy this case, Release 15 NR features a CSI omission procedure, where part of the CSI report can be dropped if the resulting UCI code rate is too low. This is achieved by segmenting the CSI payload into different priority levels and dropping CSI segment(s) starting with the lowest priority level until the UCI code rate falls below a threshold whereby the CSI payload will “fit” in the PUSCH allocation. The priority levels are described in the table below, where Priority 0 has the highest priority and N_{Rep} represents the number of CSI reports.

TABLE 5.2.3-1
Priority reporting levels for Part 2 CSI
Priority 0:
Part 2 wideband CSI for CSI reports 1 to N_{Rep}
Priority 1:
Part 2 subband CSI of even subbands for CSI report 1
Priority 2:
Part 2 subband CSI of odd subbands for CSI report 1
Priority 3:
Part 2 subband CSI of even subbands for CSI report 2
Priority 4:
Part 2 subband CSI of odd subbands for CSI report 2
Priority 2N_{Rep} − 1:
Part 2 subband CSI of even subbands for CSI report N_{Rep}
Priority 2N_{Rep}:
Part 2 subband CSI of odd subbands for CSI report N_{Rep}

For Type II CSI reporting, the wideband PMI comprises:
spatial basis indication (“W1” indication, beam indication), including rotation/oversampling factors,
wideband amplitude coefficients per layer (i.e., p_{l,i}⁽¹⁾), and
strongest coefficient indicator per layer.

For Type II CSI reporting, the subband CSI comprises:
subband phase indication c_{l,i}(k) per layer, and
subband amplitude indication per layer (if configured).

The subband PMI is the most payload heavy since it is reported independently for each subband, whereas the wideband PMI is only reported once for the entire CSI reporting band.

In the described CSI omission procedure, subband PMI for odd and even numbered subbands are respectively grouped into different CSI segments with different priorities. This implies that if the PUSCH resource allocation is too small to fit the CSI payload, the subband PMI for the odd subbands can be dropped and only subband PMI for even subbands are reported. The motivation behind this design is that the reported remaining PMI can still be used by the gNB. Since the gNB has knowledge of the subband PMI for every other subband, it can perform interpolation between subbands to estimate the PMI for the omitted subbands. Since the subband PMIs are correlated in frequency, the performance loss may not be that severe.

The Release 15 CSI report on PUSCH consists of two UCI Parts, Part 1 and Part 2. UCI Part 1 comprises RI and an indicator of the number on Non-Zero (NZ) wideband amplitude coefficients (in UCI Part 2). UCI Part 2 comprises the wideband and subband PMI. The payload of UCI Part 1 is fixed and does not vary dynamically, whereas the payload of UCI Part 2 may vary dynamically depending on the RI and number of NZ wideband amplitude coefficients. To determine the payload size of UCI Part 2, the gNB must thus first decode UCI Part 1 to recover the RI and the number of NZ wideband amplitude coefficients.

CSI omission is only performed on the UCI Part 2, since if the components of UCI Part 1 were omitted, the gNB would not have enough information to decode UCI Part 2.

7.3 Type II Overhead Reduction for NR Release 16

For NR Release 16 Type II, overhead reduction mechanisms have been specified. The rationale is that it has been observed that there is a strong correlation between different values of c_{l,i}, for different subbands, and one could exploit this correlation to perform efficient compression in order to reduce the number of bits required to represent the information. This would thus lower the amount of information which needs to be signaled from the UE to the gNB, which is relevant from several aspects.

The agreed codebook design for NR Release 16 Type II codebook can be described as follows:
Precoder vectors for all Frequency Domain (FD) units/subbands for a layer is given by size—P×N₃ matrix W=[w⁽⁰⁾ . . . w^{(N}^{₃}⁻¹⁾]=W₁\tilde{W}₂W_{f}^{H}.
   P=2N₁N₂ is the number of Spatial Domain (SD) dimensions (i.e., the number of antenna ports).
   N₃=N_{SB}×R is the number of FD dimensions (i.e., the number of PMI subbands. The value R={1, 2} and is referred to as a PMI subband size indicator. The value of R is Radio Resource Control (RRC) configured. As of the time of the writing of the present disclosure, it is for future study in 3GPP if R=2 is associated with UE capability or processing relaxations. N_{SB} is the number of CQI subbands. The equation above for N₃ applies for N_{SB}×R≤13. For N_{SB}×R>13, downselection between padding, segmentation, or same behavior is provided. It is for future study as to how to handle edge subbands.
   Precoder normalization: The precoding matrix for given rank and unit of N₃ is normalized to norm 1/sqrt(rank).
SD compression by W₁
   L spatial domain basis vectors (mapped to the two polarizations, so 2L in total) are selected.
   Compression in spatial domain is performed using

$${W}_{1} = [ \begin{matrix}{v}_{0} {v}_{1} … {v}_{L - 1} & 0 \\ 0 & {v}_{0} {v}_{1} … {v}_{L - 1}\end{matrix} ] ,$$

where {vᵢ}ᵢ₌₀^{L-1} are N₁N₂×1 orthogonal DFT vectors (same as Release 15 Type II).
The SD-basis selection is layer-common.
The value of L={2, 4, 6} and is the number of “beams” or SD-basis vectors. The value of L is RRC configured. Note that L=6 is only supported for the following limited parameter setting:

$$32 Tx , R = 1 , ( p , β ) ∈ \{ ( \frac{1}{4} , \frac{1}{4} ) , ( \frac{1}{4} , \frac{1}{2} ) , ( \frac{1}{4} , \frac{3}{4} ) , ( \frac{1}{2} , \frac{1}{4} ) \}$$

Optional UE capability: UE processing relaxations are for future study.
FD compression by W_{f}
   FD compression is provided via W_{f}=[fₖ_{₀} fₖ_{₁} . . . fₖ_{_{M-1}}], where {fₖ_{ₘ}}ₘ₌₀^{M-1} are M size-N₃×1 orthogonal DFT vectors.
   The nominal number of FD components M=┌p×N₃/R1┐, with

$$p = \{ \frac{1}{4} , \frac{1}{2} \}$$

is RRC configured. For layers 0 and 1, the nominal value of M is applied directly. For layers 3 and 4, the nominal value of M is mapped to a smaller actual value.
FD-basis selection is layer-specific.
Whether FD bases for layers are selected directly or using a two-step procedure is for future study.
Linear combination by \tilde{W}₂ (for a layer)

$${\tilde{W}}_{2} = [ \begin{matrix}{c}_{0 , 0} & … & {c}_{0 , M - 1} \\ ⋮ & ⋱ & ⋮ \\ {c}_{2 L - 1 , 0} & … & {c}_{2 L - 1 , M - 1}\end{matrix} ]$$

is composed of K=2LM Linear Combination (LC) coefficients c_{l,m}, where l is an SD-basis index and m is an FD-basis index.
Coefficient subset selection is provided as follows.
   Only a subset K_{NZ}≤K₀<2LM of the LC coefficients are NZ and reported.
      The 2LM−K_{NZ} non-reported LC coefficients are zero and not reported.
      The nominal maximum number of NZ LC coefficients per layer is K₀=┌β×2LM┐, where

$$β ∈ \{ \frac{1}{4} , \frac{1}{2} , \frac{3}{4} \}$$

is RRC configured. This applies for RI={1, 2}.
For RI={3, 4}, the total maximum number of NZ LC coefficients across all layers is less than or equal to 2K₀. It is for future study if there are any restrictions on division of coefficients among layers.
Coefficient subset selection is indicated with a size—2LM bitmap with K_{NZ} ones in UCI Part 2.
Coefficient subset selection is layer-specific.
Indication of K_{NZ} for all layers is given in UCI Part 1, so that UCI Part 2 payload can be known. It is for future study if there is joint or separate indication across layers.
Coefficient quantization for the LC coefficients is according to

$${c}_{l , m} = {p}_{ref} ( ⌊ \frac{l}{L} ⌋ ) \times p ( l , m ) \times φ ( l , m ) .$$

Strongest coefficient: A ┌log₂K_{NZ}┐ bit indicator for the Strongest Coefficient Index (SCI) (l*, m*) is included. The strongest coefficient c_{l*, m*}=1 (hence its amplitude/phase is not reported). The bitwidth of strongest coefficient indicator for RI>1 is for future study.
The parameter

$${p}_{ref} ( ⌊ \frac{l}{L} ⌋ )$$

is a reference amplitude. Two polarization-specific reference amplitudes p_{ref} (0), p_{ref} (1) are provided. For the polarization associated with the strongest coefficient,

$${p}_{ref} ( ⌊ \frac{{l}^{*}}{L} ⌋ ) = 1$$

and hence is not reported. For the other polarization, the reference amplitude is quantized to four bits, where the alphabet is

$$\{ 1 , {( \frac{1}{2} )}^{\frac{1}{4}} , {( \frac{1}{4} )}^{\frac{1}{4}} , {( \frac{1}{8} )}^{\frac{1}{4}} , … , {( \frac{1}{{2}^{14}} )}^{\frac{1}{4}} ,$$

“reserved”} (−1.5 decibel (dB) step size).
For {c_{l,m}, (l,m)≠(l*, m*)}:
   For each polarization, differential amplitudes p(l,m) of the coefficients are calculated relative to the associated polarization-specific reference amplitude and quantized to three bits, where the alphabet is

$$\{ 1 , \frac{1}{\sqrt{2}} , \frac{1}{2} , \frac{1}{2 \sqrt{2}} , \frac{1}{4} , \frac{1}{4 \sqrt{2}} , \frac{1}{8} , \frac{1}{8 \sqrt{2}} \}$$

3 dB step size).
Each phase ϕ(l,m) is quantized to either 8-Phase Shift Keying (8PSK) (3-bit) or 16-Phase Shift Keying (16PSK) (4-bit) (configurable).
   The agreed codebook structure utilizing both SD and FD compression is illustrated in FIG. 4. In other words, FIG. 4 is an illustration of matrix representation of Type II overhead reduction scheme.

The agreed UCI parameters for the Release 16 Type II codebook are summarized in Table 1 below. As can be seen, some details are yet to be determined.

TABLE 1
Agreed UCI parameters for the Rel-16 Type II codebook

| Parameter | Location | Details/description |
|---|---|---|
| # NZ coefficients | UCI part 1 | FFS: Exact design (joint or separate across layer). |
| (NZC) | | Currently two alternatives have been proposed: |
| | | Alt 1: RI + # NZC summed across layers |
| | | Alt 1-1: RI + differential of # NZC summed across |
| | | layers |
| | | Alt 2: Per-layer # NZC without RI |
| | | Alt3: RI + per layer differential # NZC |
| Wideband CQI | UCI part 1 | Same as R15 |
| Subband CQI | UCI part 1 | Same as R15 |
| Bitmap per layer | UCI part 2 | RI = 1-2: for layer /, size-2LM |
| | | FFS: exact design for RI = 3-4 (depending on subset |
| | | selection) |
| Strongest coefficient | UCI part 2 | FFS: Exact design for all layers (bitwidth, etc.), |
| indicator (SCI) | | depending on the exact design of # NZC indicator for |
| | | higher rank, extending the existing agreement on SCI: |
| | | “A ┌log₂ KN_{Z}┐-bit indicator for the strongest coefficient |
| | | index (l*, m*)” |
| SD basis subset selection indicator | UCI part 2 | $SD basis subset selection indicator is a ⌈ {log}_{2} ( \begin{matrix}{N}_{1} {N}_{2} \\ L\end{matrix} ) ⌉ -$ |
| | | bit indicator. |
| FD basis subset | UCI part 2 | FFS: |
| selection indicator | | Exact design depending on decision for SD/FD |
| | | basis parameter setup for RI = 3-4, |
| | | Exact bitwidth depending on various other |
| | | factors such as restriction or basis selection |
| | | mechanism |
| LC coefficients: | UCI part 2 | Quantized independently across layers |
| phase | | |
| LC coefficients: | UCI part 2 | Quantized independently across layers (including |
| amplitude | | reference amplitude for weaker polarization, for each |
| | | layer) |
| SD oversampling | UCI part 2 | Values of q₁, q₂ follow Rel.15 |
| (rotation) factor q₁, | | |
| q₂ | | |

### SUMMARY

Systems and methods for Channel State Information (CSI) omission for enhanced Type II CSI reporting are provided. In one embodiment, a method performed by a wireless device for CSI reporting in a cellular communications system comprises performing a CSI omission procedure to omit a deterministic portion of Uplink Control Information (UCI) for a CSI report and thereby provide a reduced-size CSI report. Performing the CSI omission procedure comprises dividing a plurality of Linear Combination (LC) coefficients into two or more CSI omission groups having associated priority levels and, based on the priority levels of the two or more CSI omission groups, omitting LC coefficients comprised in at least one of the two or more CSI omission groups from the reduced-size CSI report. The method further comprises transmitting the reduced-size CSI report. In this manner, a deterministic portion of the UCI is omitted to provide the reduced-size CSI report.

In one embodiment, the plurality of LC coefficients are phase/amplitude coefficients c_{i,m}^{(l)} for each value of a layer-index l for each value of a Spatial Domain (SD) index i for each value of a Frequency Domain (FD) index m where:
1=0, 1, . . . , v−1 where v is a number of layers of one or more precoders indicated by the CSI report;
i=0, 1, . . . , 2L−1 where L is a number of SD-basis vectors for the one or more precoders for each of two polarizations; and
m=0, 1, . . . , M−1 where M is a nominal number of FD components for the one or more precoders.

In one embodiment, the CSI report is for codebook based precoding based on a codebook having a codebook structure that utilizes both FD compression and SD compression, wherein, for each layer l, the codebook structure is according to:

$${W}^{( l )} = [ {w}^{( l ) ( 0 )} … {w}^{( l ) ( {N}_{3} - 1 )} ] = {W}_{1}^{( l )} {{\tilde{W}}_{2}^{( l )} ( {W}_{f}^{( l )} )}^{H} \qquad$$

where:
w^{(l)} is a size P×N₃ matrix that defines precoder vectors for the codebook for all FD units or subbands for the layer l,
P=2N₁N₂ is the number of SD dimensions,
N₁ is a number of antennas in a first dimension of a Two-Dimensional (2D) antenna array of the base station,
N₂ is a number of antennas in a second dimension of the 2D antenna array of the base station,
N₃=N_{SB}×R is the number of FD dimensions where R={1, 2} and is a Precoding Matrix Indicator (PMI) subband size indicator,

$${W}_{1}^{( l )} = [ \begin{matrix}{v}_{0} {v}_{1} … {v}_{L - 1} & 0 \\ 0 & {v}_{0} {v}_{1} … {v}_{L - 1}\end{matrix} ] \qquad$$

where {vᵢ}ᵢ₌₀^{L-1} are N₁N₂×1 orthogonal Discrete Fourier Transform (DFT) vectors,

$${\tilde{W}}_{2}^{( l )} = [ \begin{matrix}{c}_{0 , 0}^{( l )} & … & {c}_{0 , M - 1}^{( l )} \\ ⋮ & ⋱ & ⋮ \\ {c}_{2 L - 1 , 0}^{( l )} & … & {c}_{2 L - 1 , M - 1}^{( l )}\end{matrix} ] , \qquad$$

and
W_{f}^{(l)}=[fₖ_{₀} fₖ_{₁}, . . . fₖ_{_{M-1}}], where {fₖ_{ₘ}}ₘ₌₀^{m-1} are M size-N₃×1 orthogonal DFT vectors.

In one embodiment, dividing the plurality of LC coefficients into two or more CSI omission groups having associated priority levels comprises assigning a certain ordering to the plurality of LC coefficients and dividing the plurality of LC coefficients into two or more CSI omission groups based on the certain ordering. In one embodiment, assigning the certain ordering to the plurality of LC coefficients comprises assigning the certain ordering to the plurality of LC coefficients with respect to: (a) the layer-index l, (b) SD-basis index i, (c) FD-basis index m, or (d) any combination of two or more of (a)-(c). In one embodiment, assigning the certain ordering to the plurality of LC coefficients comprises assigning the certain ordering to the plurality of LC coefficients according to the FD-basis index m first, then the SD-basis index i, then the layer-index l. In one embodiment, the certain ordering is according to a permuted order of the FD-basis index m. In one embodiment, the permuted order of the FD-basis index m is such that FD-basis indices close to a zero lag in a modulo sense come first in the certain ordering.

In one embodiment, the UCI further comprises Non-Zero (NZ) coefficient bitmaps, and performing the CSI omission procedure further comprises assigning the same certain ordering to the NZ coefficient bitmaps and omitting bits from the NZ coefficient bitmaps according to the same certain ordering. In one embodiment, the number of omitted bits from the NZ coefficient bitmaps is equal to the number of omitted LC coefficients.

In one embodiment, assigning the certain ordering to the plurality of LC coefficients comprises assigning the certain ordering to the plurality of LC coefficients according to the layer-index l first, then the FD-basis index m, and then the SD-basis index i. In one embodiment, the certain ordering is according to a permuted order of the FD-basis index m.

In one embodiment, the plurality of LC coefficients are defined as:

$${c}_{i , m}^{( l )} = {p}_{ref} ( ⌊ \frac{i}{L} ⌋ ) \times p ( i , m ) \times φ ( i , m )$$

where:

$${p}_{ref} ( ⌊ \frac{i}{L} ⌋ )$$

is a reference amplitude,
p(i, m) is an amplitude component of the LC coefficient c_{i,m}^{(l)} relative to the reference amplitude

$${p}_{ref} ( ⌊ \frac{i}{L} ⌋ ) ,$$

and
ϕ(i,m) is a phase component.

In one embodiment, the method further comprises receiving an uplink resource allocation for transmission of the CSI report from a base station, wherein performing the CSI omission procedure comprises performing the CSI omission procedure such that a size of the reduced-size CSI report is fits within the uplink resource allocation. In one embodiment, the method further comprises determining that the size of the CSI report does not fit within the uplink resource allocation, wherein performing the CSI omission procedure comprises performing the CSI omission procedure upon determining that the size of the CSI report does not fit within the uplink resource allocation.

In one embodiment, the UCI comprises a first UCI part that comprises a Rank Indicator (RI) and a number of NZ coefficients summed across all layers and a second UCI part that comprises a SD-basis indication, a FD-basis indication per layer, SD oversampling factors, NZ coefficient bitmaps per layer, a strongest coefficient indicator per layer, the plurality of LC coefficients comprising LC coefficients for each layer, and a reference amplitude for a weaker polarization of two or more polarizations for the CSI report.

In one embodiment, the CSI report is for codebook based precoding based on a codebook having a codebook structure that utilizes both FD compression and SD compression.

Corresponding embodiments of a wireless device are also disclosed. In one embodiment, a wireless device for CSI reporting for a cellular communications system is adapted to perform a CSI omission procedure to omit a deterministic portion of UCI for a CSI report and thereby provide a reduced-size CSI report. In order to perform the CSI omission procedure, the wireless device is further adapted to divide a plurality of LC coefficients into two or more CSI omission groups having associated priority levels and, based on the priority levels of the two or more CSI omission groups, omit LC coefficients comprised in at least one of the two or more CSI omission groups from the reduced-size CSI report. The wireless device is further adapted to transmit the reduced-size CSI report.

In one embodiment, a wireless device for CSI reporting for a cellular communications system comprises one or more transmitters, one or more receivers, and processing circuitry associated with the one or more transmitters and the one or more receivers. The processing circuitry is configured to cause the wireless device to perform a CSI omission procedure to omit a deterministic portion of UCI for a CSI report and thereby provide a reduced-size CSI report. In order to perform the CSI omission procedure, the processing circuitry is configured to cause the wireless device to divide a plurality of LC coefficients into two or more CSI omission groups having associated priority levels and, based on the priority levels of the two or more CSI omission groups, omit LC coefficients comprised in at least one of the two or more CSI omission groups from the reduced-size CSI report. The processing circuitry is further configured to cause the wireless device to transmit the reduced-size CSI report.

Embodiments of a method performed by a base station are also disclosed. In one embodiment, a method performed by a base station for CSI reporting in a cellular communications system comprises receiving a reduced-size CSI report from a wireless device, where the reduced-size CSI report is a CSI report for which a portion of UCI is omitted based on a CSI omission procedure. The method further comprises decoding the reduced-size CSI report using the CSI omission procedure to determine the portion of the UCI that has been omitted. Decoding the reduced-size CSI report using the CSI omission procedure to determine the portion of the UCI that has been omitted comprises dividing a plurality of LC coefficients into two or more CSI omission groups having associated priority levels and, based on the priority levels of the two or more CSI omission groups, determining that LC coefficients comprised in at least one of the two or more CSI omission groups are omitted from the reduced-size CSI report.

In one embodiment, the plurality of LC coefficients are phase/amplitude coefficients c_{i,m}^{(l)} for each value of a layer-index l for each value of an SD-basis index l for each value of a FD-basis index m where:
l=0, 1, . . . , v−1 where v is a number of layers of one or more precoders indicated by the CSI report;
i=0, 1, . . . , 2L−1 where L is a number of SD-basis vectors for the one or more precoders for each of two polarizations; and
m=0, 1, M−1 where M is a nominal number of FD components for the one or more precoders.

In one embodiment, the reduced-size CSI report is for codebook based precoding based on a codebook having a codebook structure that utilizes both FD compression and SD compression, wherein, for each layer l, the codebook structure is according to:

$${W}^{( l )} = [ {w}^{( l ) ( 0 )} … {w}^{( l ) ( {N}_{3} - 1 )} ] = {W}_{1}^{( l )} {{\tilde{W}}_{2}^{( l )} ( {W}_{f}^{( l )} )}^{H} \qquad ( l )$$

where:
w^{(l)} is a size—P×N₃ matrix that defines precoder vectors for the codebook for all FD units or subbands for the layer l,
P=2N₁N₂ is the number of SD dimensions,
N₁ is a number of antennas in a first dimension of a 2D antenna array of the base station,
N₂ is a number of antennas in a second dimension of the 2D antenna array of the base station,
N₃=N_{SB}×R is the number of FD dimensions where R={1, 2} and is a PMI subband size indicator,

$${W}_{1}^{( l )} = [ \begin{matrix}{v}_{0} {v}_{1} … {v}_{L - 1} & 0 \\ 0 & {v}_{0} {v}_{1} … {v}_{L - 1}\end{matrix} ] \qquad$$

where {vᵢ}ᵢ₌₀^{L-1} are N₁N₂×1 orthogonal DFT vectors,

$${\tilde{W}}_{2}^{( l )} = [ \begin{matrix}{c}_{0 , 0}^{( l )} & … & {c}_{0 , M - 1}^{( l )} \\ ⋮ & ⋱ & ⋮ \\ {c}_{2 L - 1 , 0}^{( l )} & … & {c}_{2 L - 1 , M - 1}^{( l )}\end{matrix} ] ,$$

and
W_{f}^{(l)}=[fₖ_{₀} fₖ_{₁} . . . fₖ_{_{M-1}}], where {fₖ_{ₘ}}ₘ₌₀^{M-1} are M size-N₃×1 orthogonal DFT vectors.

In one embodiment, dividing the plurality of LC coefficients into two or more CSI omission groups having associated priority levels comprises assigning a certain ordering to the plurality of LC coefficients and dividing the plurality of LC coefficients into two or more CSI omission groups based on the certain ordering. In one embodiment, assigning the certain ordering to the plurality of LC coefficients comprises assigning the certain ordering to the plurality of LC coefficients with respect to: (a) the layer-index l, (b) the SD-basis index i, (c) the FD-basis index m, or (d) any combination of two or more of (a)-(c). In one embodiment, assigning the certain ordering to the plurality of LC coefficients comprises assigning the certain ordering to the plurality of LC coefficients according to the FD-basis index m first, then the SD-basis index i, then the layer-index l. In one embodiment, the certain ordering is according to a permuted order of the FD-basis index m. In one embodiment, the permuted order of the FD-basis index m is such that FD-basis indices close to a zero lag in a modulo sense come first in the certain ordering.

In one embodiment, the UCI further comprises NZ coefficient bitmaps, and decoding the reduced-size CSI report using the CSI omission procedure to determine the portion of the UCI that has been omitted further comprises assigning the same certain ordering to the NZ coefficient bitmaps and determining bits from the NZ coefficient bitmaps that are omitted according to the same certain ordering. In one embodiment, the number of omitted bits from the NZ coefficient bitmaps is equal to the number of omitted LC coefficients.

Corresponding embodiments of a base station are also disclosed. In one embodiment, a base station for CSI reporting for a cellular communications system is adapted to receive a reduced-size CSI report from a wireless device, where the reduced-size CSI report is a CSI report for which a portion of UCI is omitted based on a CSI omission procedure. The base station is further adapted to decode the reduced-size CSI report using the CSI omission procedure to determine the portion of the UCI that has been omitted. In order to decode the reduced-size CSI report using the CSI omission procedure to determine the portion of the UCI that has been omitted the CSI omission procedure, the base station is further adapted to divide a plurality of LC coefficients into two or more CSI omission groups having associated priority levels and, based on the priority levels of the two or more CSI omission groups, determine that LC coefficients comprised in at least one of the two or more CSI omission groups are omitted from the reduced-size CSI report.

In one embodiment, a base station for CSI reporting for a cellular communications system comprises processing circuitry configured to cause the base station to receive a reduced-size CSI report from a wireless device, where the reduced-size CSI report is a CSI report for which a portion of UCI is omitted based on a CSI omission procedure. The processing circuitry is further configured to cause the base station to decode the reduced-size CSI report using the CSI omission procedure to determine the portion of the UCI that has been omitted. In order to decode the reduced-size CSI report using the CSI omission procedure to determine the portion of the UCI that has been omitted the CSI omission procedure, the processing circuitry is further configured to cause the base station to divide a plurality of LC coefficients into two or more CSI omission groups having associated priority levels and, based on the priority levels of the two or more CSI omission groups, determine that LC coefficients comprised in at least one of the two or more CSI omission groups are omitted from the reduced-size CSI report.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a transmission structure of precoded spatial multiplexing mode in New Radio (NR);

FIG. 2 is an illustration of a two-dimensional (2D) antenna array of cross-polarized antenna elements (N_{P}=2), with Nₕ=4 horizontal antenna elements and Nᵥ=4 vertical antenna elements;

FIG. 3 shows an example of Channel State Information (CSI) Reference Signal (CSI-RS) Resource Elements (REs) for twelve antenna ports in NR, where one RE per Resource Block (RB) per port is shown;

FIG. 4 is an illustration of matrix representation of a Release 16 NR Type II overhead reduction scheme;

FIG. 5 illustrates one example of a cellular communications system in which embodiments of the present disclosure may be implemented;

FIG. 6 illustrates the operation of a base station (e.g., NR base station (gNB)) and a User Equipment (UE) to perform CSI omission in accordance with some embodiments of the present disclosure;

FIG. 7 is a flow chart that illustrates details of step 604 of FIG. 6 in accordance with at least some embodiments of the present disclosure;

FIG. 8 is a flow chart that illustrates details of step 608 of FIG. 6 in more detail in accordance with at least some embodiments of the present disclosure;

FIGS. 9 through 11 are schematic block diagrams of example embodiments of a radio access node;

FIGS. 12 and 13 are schematic block diagrams of example embodiments of a wireless communication device;

FIG. 14 illustrates an example of a communication system in which embodiments of the present disclosure may be implemented;

FIG. 15 illustrates example embodiments of the host computer, base station, and UE of FIG. 14; and

FIGS. 16 through 19 are flow charts illustrating methods implemented in a communication system such as the communication system of FIG. 14 in accordance with embodiments of the present disclosure.

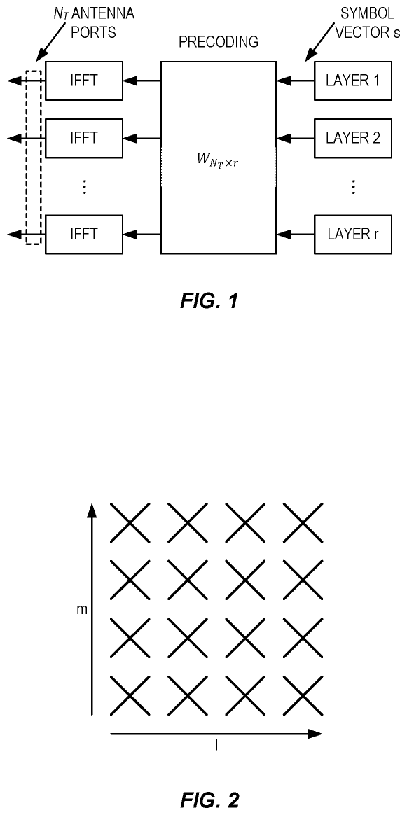

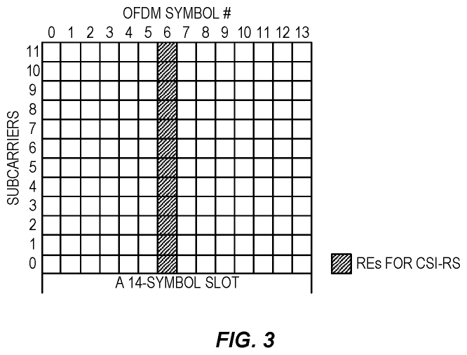

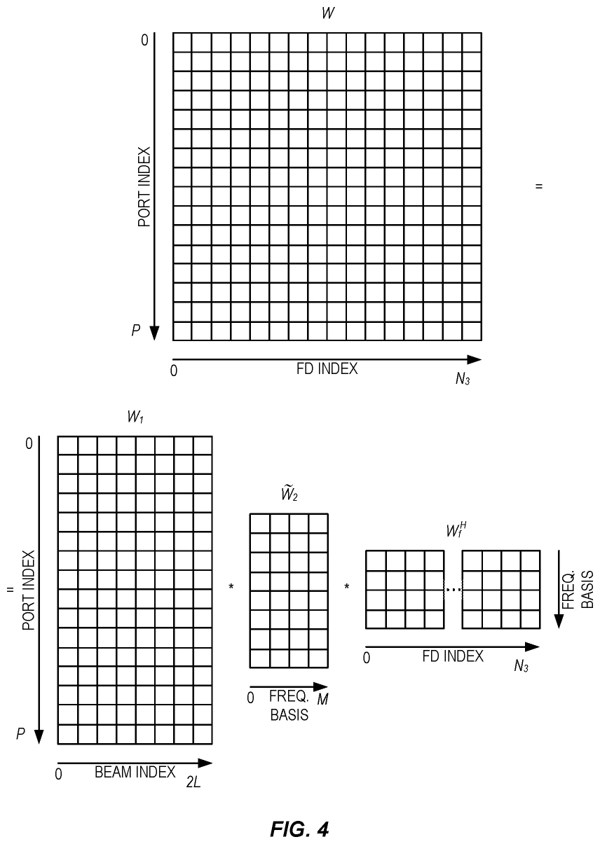

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless device.

Radio Access Node: As used herein, a “radio access node” or “radio network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Repository Function (NRF), a Policy Control Function (PCF), a Unified Data Management (UDM), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s) related to Channel State Information (CSI) reporting. The 3GPP NR Release 16 Type II codebook exhibits the same behavior with heavily rank-dependent payload as the Release 15 Type II codebook, and it is expected that a CSI omission procedure is beneficial for the Release 16 codebook as well. However, since the Release 16 Type II codebook is based on Frequency Domain (FD) compression where a set of transformed Linear Combination (LC) coefficients are reported, there is no Precoder Matrix Indicator (PMI) reporting per subband. Hence, the Release 15 CSI omission procedure cannot be directly reused, and the design of a CSI omission procedure for the new Release 16 codebook is an open problem.

Certain aspects of the present disclosure and their embodiments may provide solutions to the aforementioned or other challenges. Systems and methods are disclosed herein for providing CSI omission for the Release 16 Type II CSI codebook structure utilizing the properties of Uplink Control Information (UCI) parameters to omit a portion of the CSI such as to minimize the detrimental impact of the CSI omission and to ensure that the CSI payload or interpretation is not ambiguous. Note that while the embodiments described herein focus CSI omission for the Release 16 Type II CSI codebook structure, the embodiments described herein are not limited to the Release 16 Type II CSI codebook structure. Rather, the embodiments described herein are applicable to any similar type of CSI codebook structure.

In some embodiments, the LC coefficients as well as bits in the Non-Zero (NZ) coefficient bitmaps are assigned a certain ordering with respect to layer-index, Spatial Domain (SD) basis index, and FD-basis index. The LC coefficients are grouped into multiple CSI omission groups according to this ordering, and CSI omission groups with lower priority are omitted. Different portions of the NZ coefficient bitmaps may also be assigned to different CSI omission groups.

Certain embodiments may provide one or more of the following technical advantage(s). The solutions described herein minimize the detrimental impact of the CSI omission and ensure that the CSI payload and interpretation of CSI parameters are not ambiguous.

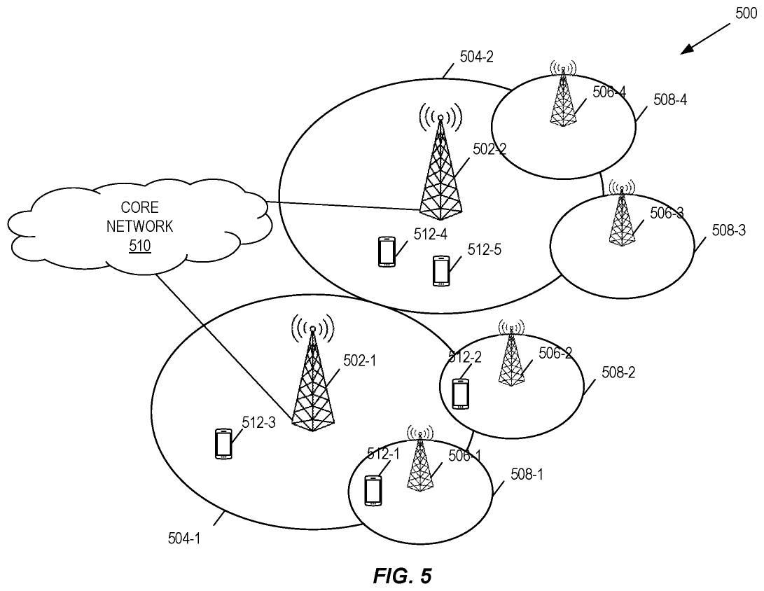

FIG. 5 illustrates one example of a cellular communications system 500 in which embodiments of the present disclosure may be implemented. In the embodiments described herein, the cellular communications system 500 is a 5G System (5GS) including a NR RAN. In this example, the RAN includes base stations 502-1 and 502-2, which in 5G NR are referred to as gNBs, controlling corresponding (macro) cells 504-1 and 504-2. The base stations 502-1 and 502-2 are generally referred to herein collectively as base stations 502 and individually as base station 502. Likewise, the (macro) cells 504-1 and 504-2 are generally referred to herein collectively as (macro) cells 504 and individually as macro cell 504. The RAN may also include a number of low power nodes 506-1 through 506-4 controlling corresponding small cells 508-1 through 508-4. The low power nodes 506-1 through 506-4 can be small base stations (such as pico or femto base stations) or Remote Radio Heads (RRHs), or the like. Notably, while not illustrated, one or more of the small cells 508-1 through 508-4 may alternatively be provided by the base stations 502. The low power nodes 506-1 through 506-4 are generally referred to herein collectively as low power nodes 506 and individually as low power node 506. Likewise, the small cells 508-1 through 508-4 are generally referred to herein collectively as small cells 508 and individually as small cell 508. The cellular communications system 500 also includes a core network 510, which in the 5GS is referred to as the 5G Core (5GC). The base stations 502 (and optionally the low power nodes 506) are connected to the core network 510.

The base stations 502 and the low power nodes 506 provide service to wireless devices 512-1 through 512-5 in the corresponding cells 504 and 508. The wireless devices 512-1 through 512-5 are generally referred to herein collectively as wireless devices 512 and individually as wireless device 512. The wireless devices 512 are also sometimes referred to herein as UEs.

The discussion will now turn to a description of embodiments of a CSI omission procedure tailored for the Release 16 Type II CSI codebook structure. This CSI omission procedure may be performed in a cellular communications system such as, e.g., the cellular communications system 500. In general, the CSI omission procedure utilizes the properties of the UCI parameters to omit a portion of the CSI such as to minimize the detrimental impact of the CSI omission and to ensure that the CSI payload or interpretation is not ambiguous.

For a CSI omission procedure to work, there needs to be a common and unambiguous understanding between the UE and the gNB of which components of the CSI (i.e., which UCI fields) are omitted and which components of the CSI are actually encoded into the UCI and transmitted. Otherwise, the gNB would either fail to correctly decode the UCI because the assumed payload is not the same as the actually transmitted payload, or, even if the payload is known, the gNB could misinterpret the payload bits since it does not know which UCI fields they correspond to.

In the Release 15 UCI omission procedure, UCI Part 1 is never omitted; and, based on the Rank Indicator (RI) and number of NZ amplitude coefficients comprised therein, the gNB can determine the (nominal) UCI Part 2 payload (i.e., before omission). Based on the nominal UCI Part 2 payload and the known Physical Uplink Shared Channel (PUSCH) resource allocation (i.e., how many Resource Elements (REs) are available for UCI on PUSCH, which in turn yields the number of coded bits), the code rate for the nominal UCI Part 2 can be calculated in the same fashion as the code rate is calculated by the UE. To determine the actual UCI Part 2 payload transmitted by the UE, the gNB simply applies the same CSI omission procedure calculation as the UE, omitting CSI segments until the code rate falls below the threshold. There is thus a common understanding between the UE and gNB regarding which components of the CSI have been omitted, which enables the gNB to determine the actual transmitted CSI payload and the correct interpretation of the UCI bits. This is a desirable and necessary property of the UCI omission procedure.

The intention with the CSI omission procedure is that the UE does not impact the CSI calculation. That is, the UE only omits part of the CSI and does not optimize the CSI calculation based on the available resources.

The relevant content of the Release 16 Type II CSI from the perspective of CSI omission will now be described. In this regard, note that superscript “(1)” is used herein to denote “layer l. This same notation can be used to describe the NR Release 16 Type II CSI codebook as:

$${W}^{( l )} = [ {w}^{( l ) ( 0 )} … {w}^{( l ) ( {N}_{3} - 1 )} ] = {W}_{1}^{( l )} {{\tilde{W}}_{2}^{( l )} ( {W}_{f}^{( l )} )}^{H} \qquad ( l )$$

where:
w^{(l)} is a size—P×N₃ matrix that defines precoder vectors for the codebook for all FD units or subbands for the layer l,
P=2N₁N₂ is the number of SD dimensions,
N₁ is a number of antennas in a first dimension of a 2D antenna array of the base station,
N₂ is a number of antennas in a second dimension of the 2D antenna array of the base station,
N₃=N_{SB}×R is the number of FD dimensions where R={1, 2} and is a Precoding Matrix Indicator, PMI, subband size indicator,

$${W}_{1}^{( l )} = [ \begin{matrix}{v}_{0} {v}_{1} … {v}_{L - 1} & 0 \\ 0 & {v}_{0} {v}_{1} … {v}_{L - 1}\end{matrix} ] \qquad$$

where {vᵢ}ᵢ₌₀^{L-1} are N₁N₂×1 orthogonal Discrete Fourier Transform, DFT, vectors,

$${\tilde{W}}_{2}^{( l )} = [ \begin{matrix}{c}_{0 , 0}^{( l )} & … & {c}_{0 , M - 1}^{( l )} \\ ⋮ & ⋱ & ⋮ \\ {c}_{2 L - 1 , 0}^{( l )} & … & {c}_{2 L - 1 , M - 1}^{( l )}\end{matrix} ] ,$$

and
W_{f}^{(l)}=[fₖ_{₀} fₖ_{₁} . . . fₖ_{_{M-1}}], where {fₖ_{ₘ}}ₘ₌₀^{M-1} are M size-N₃×1 orthogonal DFT vectors.

In Release 16 Type II CSI, the UCI Part 1 will likely comprise an RI and the number of NZ coefficients summed across all layers. This is different from Release 15 where the number of NZ coefficients were given per layer. The UCI Part 2 will comprise:
basis indications (indication of the SD-basis, FD-basis (per layer), and SD-basis oversampling factors);
NZ Coefficient Bitmaps per layer (NZCBₗ), each of size 2LMₗ for layer l;
Strongest Coefficient Indicator per layer (SCIₗ);
LC coefficients, which are Phase/amplitude coefficients c_{i,m}^{(l)} for each layer l, where l is the layer-index (l=0, 1, . . . , v−1, where v is a number of layers of one or more precoders indicated by the CSI report), i is the SD-basis index (i=0, 1, . . . , 2L−1 where L is a number of spatial domain basis vectors for the one or more precoders for each of two polarizations), and in is the FD-basis index (m=0, 1, . . . , M−1 where M is a nominal number of frequency domain components for the one or more precoders); and
reference amplitude for the weaker polarization p_{ref}.

The basis indications are necessary to be included in the CSI, as that gives the interpretation remaining CSI parameter. The NZ coefficient bitmaps are also crucial, since they comprise both the information regarding how the total number of NZ LC coefficients (which is indicated in UCI Part 1) are distributed between the multiple layers and the information that indicates which LC coefficients are included. For instance, consider an example in which a total of K_{NZ}^{TOT}=6 NZ coefficients summed across layers are indicated in UCI Part 1, L=M=2 and thus 2LM=8 and the RI=2. The bitmaps for layers 0 and 1 may then for instance be NZCB₀=‘10101100’ and NZCB₁=‘00110000’ respectively. Each bit n of the bitmap corresponds to a SD-basis index i and an FD-basis index m for instance according to n=2L·m+i where a ‘1’ in the bitmap indicates that the LC coefficient corresponding to that SD/FD basis combination is NZ and thus present and reported in UCI. Prior to reading the bitmap, the gNB only knows that 6 LC coefficients are present in UCI, but does not know which layers, SD bases, and FD bases they correspond to. That is, the gNB knows that the LC coefficients c_{A}, c_{B}, c_{C}, c_{D}, c_{E}, c_{F} are present in UCI, but only after reading the bitmaps can the gNB first infer that, e.g., c_{A}, c_{B}, c_{C}, c_{D}, correspond to layer 0 and the coefficients c_{0,0}⁽⁰⁾, c_{2,0}⁽⁰⁾, c_{0,1}⁽⁰⁾, c_{1,1}⁽⁰⁾ while c_{E}, c_{F} corresponds to layer 1 and the coefficients c_{2,0}⁽⁰⁾, c_{3,0}⁽⁰⁾ (here assuming an example way of ordering the coefficients).

In addition to this, the strongest LC coefficient as indicated by the SCI per layer is not reported. Two methods of encoding the SCI have been proposed. In the first method, it is assumed that the strongest coefficient of a layer always belongs to the first FD component (e.g., the first 2L bits of the bitmap) and the SCI needs only to range from 0, . . . , 2L−1 and the interpretation of the SCI is which SD component the strongest coefficient belongs to. In the second method, the strongest coefficient can belong to any FD component and the SCI takes a value between 0, . . . , K_{NZ}^{TOT}−1 (since in the extreme case all NZ coefficients would belong to one layer). In this case, the SCI indicates which ‘1’ in the bitmap for a layer corresponds to the strongest coefficient. Regardless of how the SCI is indicated, the consequence is that one NZ coefficient is assumed to be ‘1’ and not reported. For example, consider NZCB₁=‘00110000’ and SCI indicates that the coefficient for SD component 3 and FD component 0 is the strongest coefficient (i.e., the second ‘1’ in the bitmap). This implies that only the LC coefficient c_{2,0}⁽¹⁾ is reported for the second layer.

The reference amplitude is also required to be read in order to interpret the LC coefficients, since the amplitudes of the LC coefficients corresponding to the weaker polarization are given relative to the reference amplitude (i.e., differential amplitude reporting).

In summary, the NZ coefficient bitmaps, the reference amplitude, and the SCIs are required in order to interpret the reported LC coefficients correctly.

In accordance with embodiments of the present disclosure, a method for UCI omission for the Release 16 Type II CSI report is provided wherein the UCI parameters (or individual bits of UCI parameters) in UCI Part 2 are grouped into two or more CSI omission groups, where each group has a certain priority level and UCI parameters of the different groups are omitted according to the priority level of the group as part of the CSI omission procedure.

In a first embodiment, the SD-basis indication and FD-basis indication are given a relatively higher priority compared to other UCI parameters and may be comprised in the same CSI omission group which may have the highest priority among the CSI omission groups.

In a second embodiment, the LC coefficients may be split up in two or more CSI omission groups with different respective priority levels so that some LC coefficients in one group are omitted while other LC coefficients in other groups are not omitted and reported. One naïve approach would be to, for instance, introduce a fixed rule to omit LC coefficients corresponding to a portion of the layers, a portion of the FD-basis vectors, or a portion of the SD-basis vectors. However, directly applying such a rule would not work since, as discussed previously, the gNB is not aware of the interpretation of the LC coefficients before reading the NZ coefficient bitmaps and Strongest Coefficient Indices (SCIs). For instance, if a rule was introduced to omit LC coefficients corresponding to half of the layers, the UCI part 2 payload would be ambiguous to the gNB since it does not know the distribution of LC coefficients among the layers. The gNB only knows the total number of LC coefficients summed across layers. The same is true for, e.g., omitting LC coefficients for some SD-basis vectors. The actual number of NZ LC coefficients associated with an SD-basis vector can vary and is not known to the gNB prior to UCI Part 2 decoding and, hence, this cannot be directly used as a CSI omission procedure.

Instead, in one embodiment, the K_{NZ}^{TOT} LC coefficients are divided into CSI omission groups in a predictable manner so that the number of LC coefficients in each CSI omission group is known prior to decoding UCI Part 2. For instance, the LC coefficients are divided between two CSI omission groups where

$$⌈ \frac{{K}_{N Z}^{T O T}}{2} ⌉$$

coefficients are included in a first CSI omission group and the remaining

$${K}_{N Z}^{T O T} - ⌈ \frac{{K}_{N Z}^{T O T}}{2} ⌉$$

coefficients are included a second CSI omission group.

The next question is how to perform the said division. In one embodiment, the reported LC coefficients c_{i,m}^{(l)} are assigned a certain ordering (for instance in the manner of which they are mapped to bits in UCI) and are divided into CSI omission groups according to this ordering. Let's again consider the example where L=M=2, RI=2, K_{NZ}^{TOT}=6 and where the following LC coefficients are to be reported:

$${c}_{A} , {c}_{B} , {c}_{C} , {c}_{D} , {c}_{E} , {c}_{F} = {c}_{0 , 0}^{( 0 )} , {c}_{2 , 0}^{( 0 )} , {c}_{0 , 1}^{( 0 )} , {c}_{1 , 1}^{( 0 )} , {c}_{2 , 0}^{( 1 )} , {c}_{3 , 0}^{( 1 )} \qquad ( 0 )$$

In one example, the ordering is according to layer-index (l) first, then FD beam index (m) (FD-basis index), then SD beam index (i) (SD-basis index). This implies that {c_{0,0}⁽⁰⁾, c_{2,0}⁽⁰⁾, c_{0,1}⁽⁰⁾} are included in the first CSI omission group while {c_{1,1}⁽⁰⁾, c_{2,0}⁽¹⁾, c_{3,0}⁽¹⁾} are included in the second CSI omission group. This means that all of the coefficients corresponding to the second layer (and one coefficient corresponding to the first layer) in this example would be dropped in case of CSI omission of the second CSI omission group. This may not be desirable since it reduces the effective rank of the precoder.

In another example, the ordering is instead according to FD beam index (m) (FD-basis index) first, then SD beam index (i) (SD-basis index), then layer-index (l):

$${c}_{A} , {c}_{B} , {c}_{C} , {c}_{D} , {c}_{E} , {c}_{F} = {c}_{0 , 0}^{( 0 )} , {c}_{2 , 0}^{( 0 )} , {c}_{2 , 0}^{( 1 )} , {c}_{3 , 0}^{( 1 )} {c}_{0 , 1}^{( 0 )} , {c}_{1 , 1}^{( 0 )}$$

In this case, {c_{0,0}⁽⁰⁾, c_{2,0}⁽⁰⁾, c_{2,0}⁽¹⁾} are included in the first CSI omission group while {c_{3,0}⁽¹⁾, c_{0,1}⁽⁰⁾, c_{1,1}⁽⁰⁾} are included in the second CSI omission group. This means that excess FD components are “sacrificed” in case of CSI omission. This is generally more favorable from a performance perspective than dropping entire layers or SD bases.

In one embodiment, the order by which coefficients for different FD-basis vectors are ordered is according to a permutated order of the FD-basis index. For instance, it has been observed that FD-basis indices, which correspond to DFT vectors and therefore indirectly delay taps of the channel (or lags), close to the zero lag in a modulo sense contribute more to the total channel energy. Therefore, in some embodiments, those FD components are prioritized over ones corresponding to larger lags if CSI omission must be performed. For instance, a permutation of the FD-basis index m′=f(m) can be defined, where f(m) may be defined by the following sequence 0, 1, N₃−1, 2, N₃−2, . . . .

As discussed previously in this disclosure, the NZ coefficient bitmaps may generally not be omitted since they are required to correctly interpret the LC coefficients. However, if the LC coefficients are dropped in a predictable manner, a portion of the NZ coefficient bitmaps can be omitted (i.e., a subset of the bits) if those bits are not needed to determine the interpretation of the non-omitted LC coefficients. For instance, if all the LC coefficients for FD component 1 have been omitted, the corresponding bits do not have to be included in the NZ coefficient bitmap. However, do recall that the number of bits omitted from the NZ coefficient bitmaps must be known to the gNB prior to decoding UCI Part 2 (to know its size) and unless some additional information is provided, the gNB cannot a priori know that all LC coefficients from a certain FD component have been omitted.

To solve this issue, in one embodiment, it is proposed to order the bits of the NZ coefficient bitmaps in the same order as the LC coefficients and omit bits in the bitmaps according to this order. This must be done in a fashion so that in the “worst case” the gNB can still interpret the LC coefficients. Using our previous example, the NZ coefficient bitmaps for two layers and L=M=2 will be a size-12 bitmap in total. Depending on the distribution of NZ LC coefficients among layers, SD bases, and FD bases (which is not known a priori), different numbers of bits from the bitmap can be removed. Consider that out of six NZ coefficients, three are omitted. In the best-case distribution, the three remaining coefficients corresponds to the first three bits of the bitmap, e.g. ‘111001001001’. In this case, the last 9 bits of the bitmap can be omitted since they are not needed to interpret the remaining LC coefficients. However, this cannot be known a priori. If instead we have the worst-case distribution, where the omitted coefficients correspond to the last bits of the bitmap, e.g. ‘100001001111’, only the last 3 bits can be omitted. This property generally holds. Thus, in an embodiment, if N LC coefficients are omitted, the last N bits of the NZ coefficient bitmap(s) are also omitted.

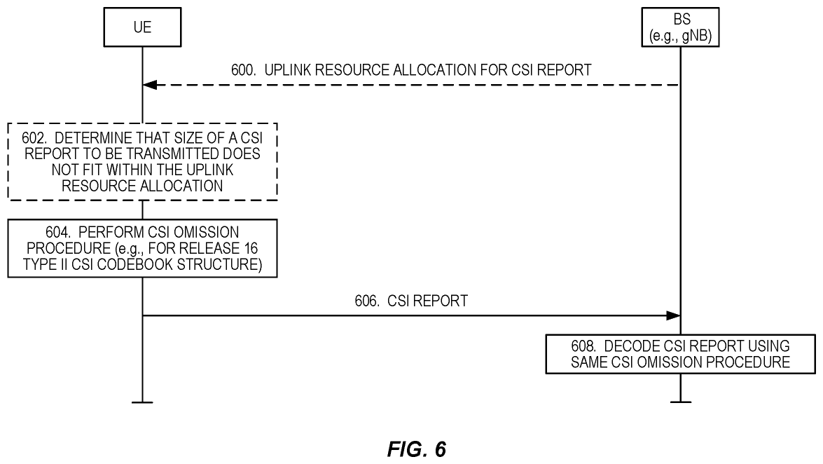

FIG. 6 illustrates the operation of a base station (e.g., gNB) and a UE to perform CSI omission in accordance with some embodiments of the present disclosure. Optional steps are represented by dashed lines/boxes. As illustrated, the base station transmits, to the UE, an uplink resource allocation for a CSI report to be transmitted by the UE (step 600). At the UE, the UE determines that a size of the CSI report does not fit within the uplink resource allocation (step 602). The UE then performs a CSI omission procedure to thereby omit a deterministic portion of UCI comprised in the CSI report, thereby providing a reduced-size CSI report that fits within the uplink resource allocation (step 604). The UE then transmits the reduced-size CSI report to the base station in accordance with the uplink resource allocation (step 606). At the base station, the base station receives and decodes the CSI report using the same CSI omission procedure (step 608).

As discussed above, in some embodiments, the CSI omission procedure is tailored for the Release 16 Type II CSI report. Further, in some embodiments, UCI parameters or individual UCI bits of UCI parameters in UCI Part 2 are grouped into two or more CSI omission groups, where each group has a certain priority level. UCI parameters or individual bits of UCI parameters of the different CSI omission groups are omitted to the priority levels of the different CSI omission groups during the CSI omission procedure, e.g. until the resulting size of the CSI report fits within the uplink resource.

In some embodiments, the LC coefficients comprised in the UCI are assigned a certain ordering with respect to layer-index, SD-basis index, and/or FD-basis index. The LC coefficients are grouped into the two or more CSI omission groups according to their ordering. In some other embodiments, both the LC coefficients and corresponding NZ coefficient bitmaps are assigned a certain ordering with respect to layer-index, SD-basis index, and/or FD-basis index. The LC coefficients and the corresponding NZ coefficient bitmaps are grouped into the two or more CSI omission groups according to their ordering. As discussed above, in some embodiments, the ordering is according to layer-index first, then FD-basis index, then SD-basis index. In some other embodiments, the ordering is by FD-basis index first, then SD-basis index, then layer-index. In some other embodiments, the ordering is according to a permuted order of the FD-basis index. In one embodiment, the permuted order of the FD-basis index prioritizes FD-basis indices close to the zero lag in a modulo sense (e.g., those FD-basis indices come first).

In some embodiments, the number of CSI omission groups is deterministic such that the number of LC coefficients in each CSI omission group is known prior to decoding UCI Part 2.

Note that while the discussion of FIG. 6 does not include all of the details of the embodiments of the CSI omission procedure described above, all of the details of the CSI omission procedure described above are applicable to the process of FIG. 6.

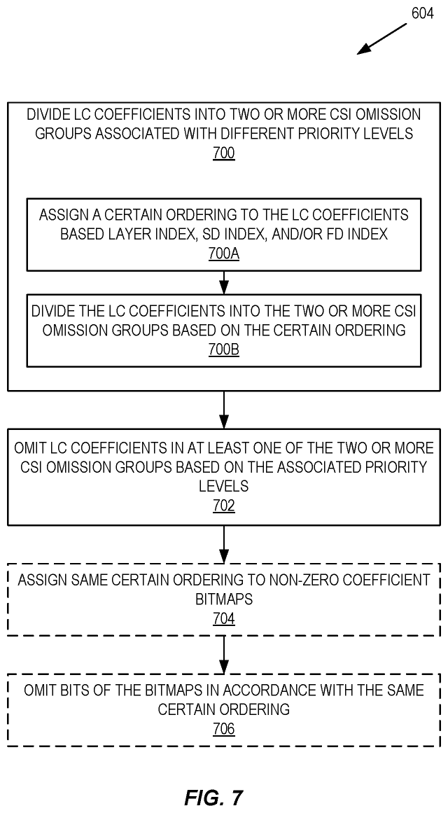

FIG. 7 is a flow chart that illustrates details of step 604 of FIG. 6 in accordance with at least some of the embodiments described above. Nothing new is presented in FIG. 7. FIG. 7 simply illustrates at least some aspects of what is described above. Optional steps are represented by dashed lines. As illustrated, in order to perform the CSI omission procedure, the UE divides the LC coefficients into two or more CSI omission groups, where the CSI omission groups have associated priorities or priority levels (step 700). More specifically, as described above, the UE assigns a certain ordering to the LC coefficients based on the layer-index l, the SD-basis index i, and/or the FD-basis index m (step 700A). The UE divides the LC coefficients into two or more groups based on the ordering, as described above (step 700B). The UE omits the LC coefficients in at least one of the CSI omission groups, as described above (step 702). Optionally, the UE also applies the same ordering to the bits in the NZ coefficient bitmaps (step 704) and omits bits from the NZ bitmaps based on this ordering (step 706). In other words, the bits in the NZ bitmaps are divided into the CSI omission groups based on their ordering and the bits in at least one of the lower priority CSI omission groups are omitted, as described above.

FIG. 8 is a flow chart that illustrates details of step 608 of FIG. 6 in more detail. Nothing new is presented in FIG. 8. FIG. 8 simply illustrates at least some aspects of what is described above. Optional steps are represented by dashed lines. As illustrated, in order to decode the received CSI information, the base station divides the LC coefficients into two or more CSI omission groups, where the CSI omission groups have associated priorities or priority levels (step 800). More specifically, as described above, the base station assigns a certain ordering to the LC coefficients based on the layer-index l, the SD-basis index i, and/or the FD-basis index m (step 800A). The base station divides the LC coefficients into two or more groups based on the ordering, as described above (step 800B). The base station determines which LC coefficients in at least one of the CSI omission groups are omitted from the CSI report, as described above (step 802). Optionally, the base station also applies the same ordering to the bits in the NZ coefficient bitmaps (step 804) and determines which bits are omitted from the NZ bitmaps based on this ordering (step 806). In other words, the bits in the NZ bitmaps are divided into the CSI omission groups based on their ordering and the base station determines that the bits in at least one of the lower priority CSI omission groups are omitted, as described above.

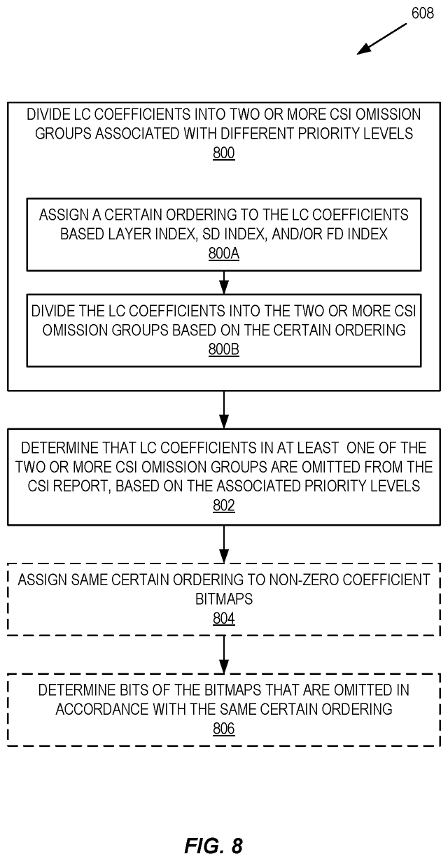

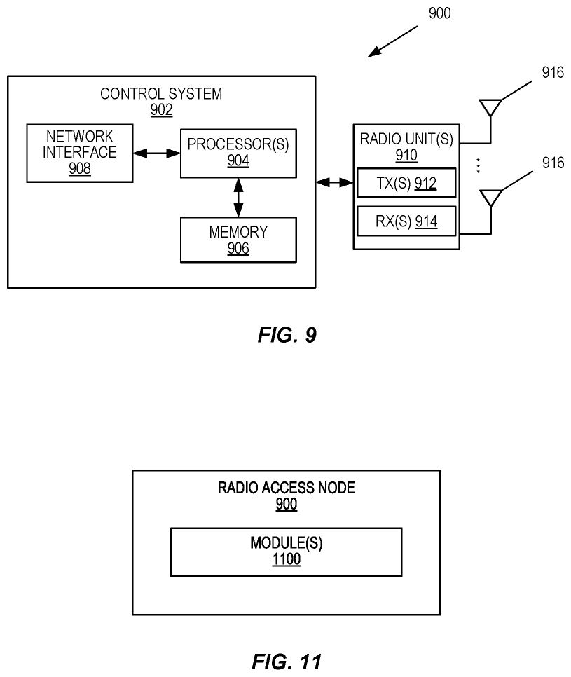

FIG. 9 is a schematic block diagram of a radio access node 900 according to some embodiments of the present disclosure. The radio access node 900 may be, for example, a base station 502 or 506 or the basis station (e.g., gNB) described above, e.g., with respect to FIG. 6. As illustrated, the radio access node 900 includes a control system 902 that includes one or more processors 904 (e.g., Central Processing Units (CPUs), Application Specific Integrated Circuits (ASICs), Field Programmable Gate Arrays (FPGAs), and/or the like), memory 906, and a network interface 908. The one or more processors 904 are also referred to herein as processing circuitry. In addition, the radio access node 900 includes one or more radio units 910 that each includes one or more transmitters 912 and one or more receivers 914 coupled to one or more antennas 916. The radio units 910 may be referred to or be part of radio interface circuitry. In some embodiments, the radio unit(s) 910 is external to the control system 902 and connected to the control system 902 via, e.g., a wired connection (e.g., an optical cable). However, in some other embodiments, the radio unit(s) 910 and potentially the antenna(s) 916 are integrated together with the control system 902. The one or more processors 904 operate to provide one or more functions of a radio access node 900 as described herein (e.g., one or more functions of a basis station (e.g., gNB) described above, e.g., with respect to FIG. 6). In some embodiments, the function(s) are implemented in software that is stored, e.g., in the memory 906 and executed by the one or more processors 904.

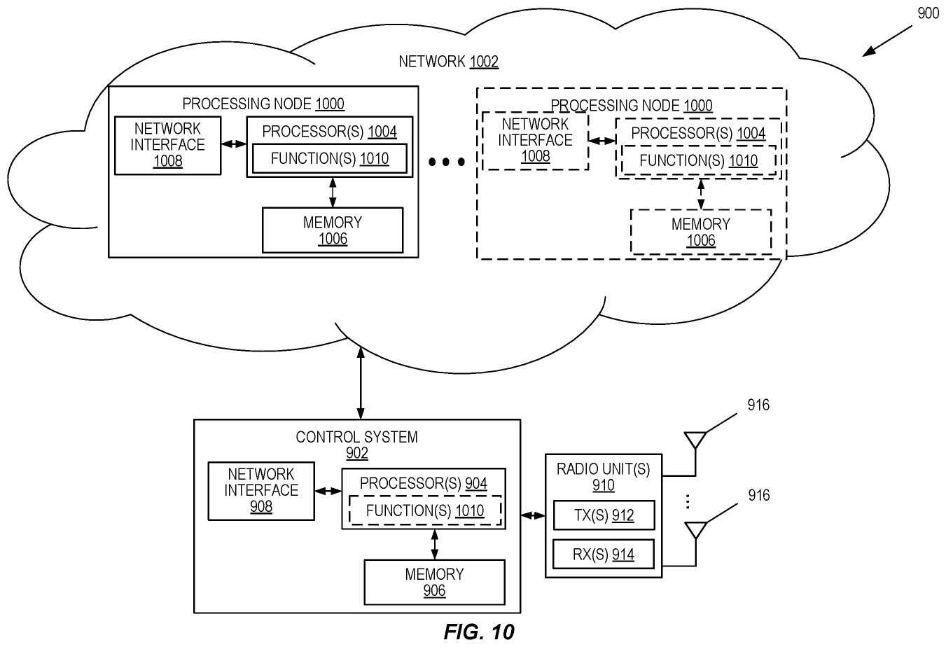

FIG. 10 is a schematic block diagram that illustrates a virtualized embodiment of the radio access node 900 according to some embodiments of the present disclosure. This discussion is equally applicable to other types of network nodes. Further, other types of network nodes may have similar virtualized architectures.

As used herein, a “virtualized” radio access node is an implementation of the radio access node 900 in which at least a portion of the functionality of the radio access node 900 is implemented as a virtual component(s) (e.g., via a virtual machine(s) executing on a physical processing node(s) in a network(s)). As illustrated, in this example, the radio access node 900 includes the control system 902 that includes the one or more processors 904 (e.g., CPUs, ASICs, FPGAs, and/or the like), the memory 906, and the network interface 908 and the one or more radio units 910 that each includes the one or more transmitters 912 and the one or more receivers 914 coupled to the one or more antennas 916, as described above. The control system 902 is connected to the radio unit(s) 910 via, for example, an optical cable or the like. The control system 902 is connected to one or more processing nodes 1000 coupled to or included as part of a network(s) 1002 via the network interface 908. Each processing node 1000 includes one or more processors 1004 (e.g., CPUs, ASICs, FPGAs, and/or the like), memory 1006, and a network interface 1008.

In this example, functions 1010 of the radio access node 900 described herein (e.g., one or more functions of a basis station (e.g., gNB) described above, e.g., with respect to FIG. 6) are implemented at the one or more processing nodes 1000 or distributed across the control system 902 and the one or more processing nodes 1000 in any desired manner. In some particular embodiments, some or all of the functions 1010 of the radio access node 900 described herein (e.g., one or more functions of a basis station (e.g., gNB) described above, e.g., with respect to FIG. 6) are implemented as virtual components executed by one or more virtual machines implemented in a virtual environment(s) hosted by the processing node(s) 1000. As will be appreciated by one of ordinary skill in the art, additional signaling or communication between the processing node(s) 1000 and the control system 902 is used in order to carry out at least some of the desired functions 1010. Notably, in some embodiments, the control system 902 may not be included, in which case the radio unit(s) 910 communicate directly with the processing node(s) 1000 via an appropriate network interface(s).

In some embodiments, a computer program including instructions which, when executed by at least one processor, causes the at least one processor to carry out the functionality of radio access node 900 (e.g., one or more functions of a basis station (e.g., gNB) described above, e.g., with respect to FIG. 6) or a node (e.g., a processing node 1000) implementing one or more of the functions 1010 of the radio access node 900 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of the radio access node 900 according to some other embodiments of the present disclosure. The radio access node 900 includes one or more modules 1100, each of which is implemented in software. The module(s) 1100 provide the functionality of the radio access node 900 described herein (e.g., one or more functions of a basis station (e.g., gNB) described above, e.g., with respect to FIG. 6). This discussion is equally applicable to the processing node 1000 of FIG. 10 where the modules 1100 may be implemented at one of the processing nodes 1000 or distributed across multiple processing nodes 1000 and/or distributed across the processing node(s) 1000 and the control system 902.

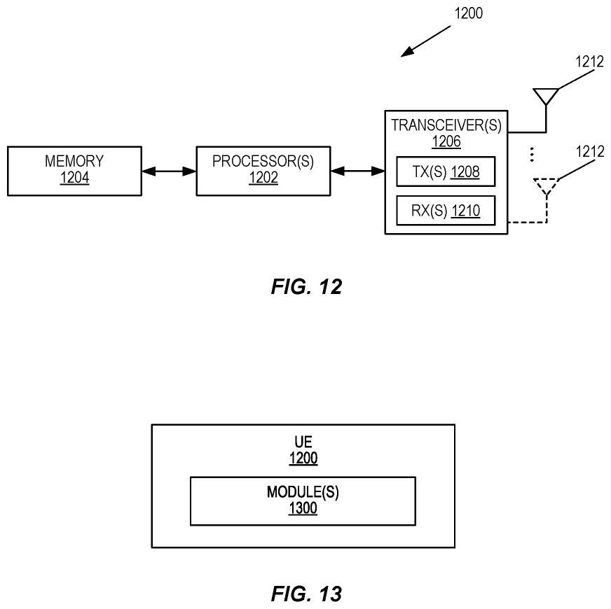

FIG. 12 is a schematic block diagram of a UE 1200 according to some embodiments of the present disclosure. As illustrated, the UE 1200 includes one or more processors 1202 (e.g., CPUs, ASICs, FPGAs, and/or the like), memory 1204, and one or more transceivers 1206 each including one or more transmitters 1208 and one or more receivers 1210 coupled to one or more antennas 1212. The transceiver(s) 1206 includes radio-front end circuitry connected to the antenna(s) 1212 that is configured to condition signals communicated between the antenna(s) 1212 and the processor(s) 1202, as will be appreciated by on of ordinary skill in the art. The processors 1202 are also referred to herein as processing circuitry. The transceivers 1206 are also referred to herein as radio circuitry. In some embodiments, the functionality of the UE 1200 described above (e.g., one or more functions of a wireless device or UE described above, e.g., with respect to FIG. 6) may be fully or partially implemented in software that is, e.g., stored in the memory 1204 and executed by the processor(s) 1202. Note that the UE 1200 may include additional components not illustrated in FIG. 12 such as, e.g., one or more user interface components (e.g., an input/output interface including a display, buttons, a touch screen, a microphone, a speaker(s), and/or the like and/or any other components for allowing input of information into the UE 1200 and/or allowing output of information from the UE 1200), a power supply (e.g., a battery and associated power circuitry), etc.

In some embodiments, a computer program including instructions which, when executed by at least one processor, causes the at least one processor to carry out the functionality of the UE 1200 according to any of the embodiments described herein (e.g., one or more functions of a wireless device or UE described above, e.g., with respect to FIG. 6) is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the UE 1200 according to some other embodiments of the present disclosure. The UE 1200 includes one or more modules 1300, each of which is implemented in software. The module(s) 1300 provide the functionality of the UE 1200 described herein (e.g., one or more functions of a wireless device or UE described above, e.g., with respect to FIG. 6).

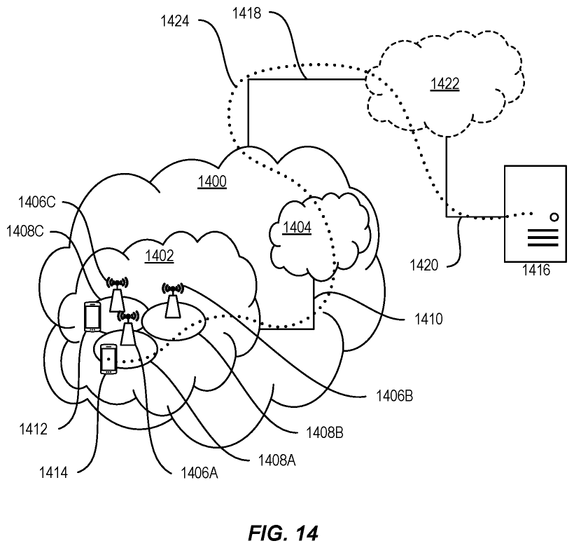

With reference to FIG. 14, in accordance with an embodiment, a communication system includes a telecommunication network 1400, such as a 3GPP-type cellular network, which comprises an access network 1402, such as a RAN, and a core network 1404. The access network 1402 comprises a plurality of base stations 1406A, 1406B, 1406C, such as Node Bs, eNBs, gNBs, or other types of wireless Access Points (APs), each defining a corresponding coverage area 1408A, 1408B, 1408C. Each base station 1406A, 1406B, 1406C is connectable to the core network 1404 over a wired or wireless connection 1410. A first UE 1412 located in coverage area 1408C is configured to wirelessly connect to, or be paged by, the corresponding base station 1406C. A second UE 1414 in coverage area 1408A is wirelessly connectable to the corresponding base station 1406A. While a plurality of UEs 1412, 1414 are illustrated in this example, the disclosed embodiments are equally applicable to a situation where a sole UE is in the coverage area or where a sole UE is connecting to the corresponding base station 1406.

The telecommunication network 1400 is itself connected to a host computer 1416, which may be embodied in the hardware and/or software of a standalone server, a cloud-implemented server, a distributed server, or as processing resources in a server farm. The host computer 1416 may be under the ownership or control of a service provider, or may be operated by the service provider or on behalf of the service provider. Connections 1418 and 1420 between the telecommunication network 1400 and the host computer 1416 may extend directly from the core network 1404 to the host computer 1416 or may go via an optional intermediate network 1422. The intermediate network 1422 may be one of, or a combination of more than one of, a public, private, or hosted network; the intermediate network 1422, if any, may be a backbone network or the Internet; in particular, the intermediate network 1422 may comprise two or more sub-networks (not shown).

The communication system of FIG. 14 as a whole enables connectivity between the connected UEs 1412, 1414 and the host computer 1416. The connectivity may be described as an Over-the-Top (OTT) connection 1424. The host computer 1416 and the connected UEs 1412, 1414 are configured to communicate data and/or signaling via the OTT connection 1424, using the access network 1402, the core network 1404, any intermediate network 1422, and possible further infrastructure (not shown) as intermediaries. The OTT connection 1424 may be transparent in the sense that the participating communication devices through which the OTT connection 1424 passes are unaware of routing of uplink and downlink communications. For example, the base station 1406 may not or need not be informed about the past routing of an incoming downlink communication with data originating from the host computer 1416 to be forwarded (e.g., handed over) to a connected UE 1412. Similarly, the base station 1406 need not be aware of the future routing of an outgoing uplink communication originating from the UE 1412 towards the host computer 1416.

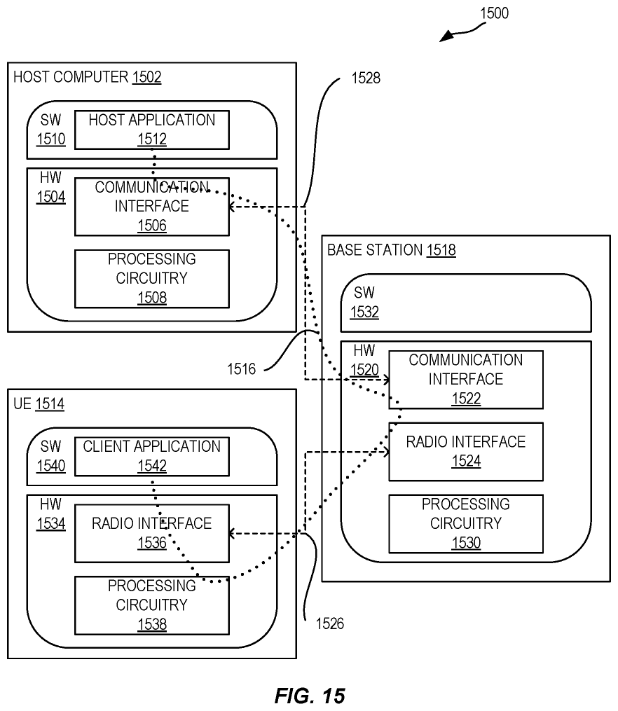

Example implementations, in accordance with an embodiment, of the UE, base station, and host computer discussed in the preceding paragraphs will now be described with reference to FIG. 15. In a communication system 1500, a host computer 1502 comprises hardware 1504 including a communication interface 1506 configured to set up and maintain a wired or wireless connection with an interface of a different communication device of the communication system 1500. The host computer 1502 further comprises processing circuitry 1508, which may have storage and/or processing capabilities. In particular, the processing circuitry 1508 may comprise one or more programmable processors, ASICs, FPGAs, or combinations of these (not shown) adapted to execute instructions. The host computer 1502 further comprises software 1510, which is stored in or accessible by the host computer 1502 and executable by the processing circuitry 1508. The software 1510 includes a host application 1512. The host application 1512 may be operable to provide a service to a remote user, such as a UE 1514 connecting via an OTT connection 1516 terminating at the UE 1514 and the host computer 1502. In providing the service to the remote user, the host application 1512 may provide user data which is transmitted using the OTT connection 1516.

The communication system 1500 further includes a base station 1518 provided in a telecommunication system and comprising hardware 1520 enabling it to communicate with the host computer 1502 and with the UE 1514. The hardware 1520 may include a communication interface 1522 for setting up and maintaining a wired or wireless connection with an interface of a different communication device of the communication system 1500, as well as a radio interface 1524 for setting up and maintaining at least a wireless connection 1526 with the UE 1514 located in a coverage area (not shown in FIG. 15) served by the base station 1518. The communication interface 1522 may be configured to facilitate a connection 1528 to the host computer 1502. The connection 1528 may be direct or it may pass through a core network (not shown in FIG. 15) of the telecommunication system and/or through one or more intermediate networks outside the telecommunication system. In the embodiment shown, the hardware 1520 of the base station 1518 further includes processing circuitry 1530, which may comprise one or more programmable processors, ASICs, FPGAs, or combinations of these (not shown) adapted to execute instructions. The base station 1518 further has software 1532 stored internally or accessible via an external connection.

The communication system 1500 further includes the UE 1514 already referred to. The UE's 1514 hardware 1534 may include a radio interface 1536 configured to set up and maintain a wireless connection 1526 with a base station serving a coverage area in which the UE 1514 is currently located. The hardware 1534 of the UE 1514 further includes processing circuitry 1538, which may comprise one or more programmable processors, ASICs, FPGAs, or combinations of these (not shown) adapted to execute instructions. The UE 1514 further comprises software 1540, which is stored in or accessible by the UE 1514 and executable by the processing circuitry 1538. The software 1540 includes a client application 1542. The client application 1542 may be operable to provide a service to a human or non-human user via the UE 1514, with the support of the host computer 1502. In the host computer 1502, the executing host application 1512 may communicate with the executing client application 1542 via the OTT connection 1516 terminating at the UE 1514 and the host computer 1502. In providing the service to the user, the client application 1542 may receive request data from the host application 1512 and provide user data in response to the request data. The OTT connection 1516 may transfer both the request data and the user data. The client application 1542 may interact with the user to generate the user data that it provides.

It is noted that the host computer 1502, the base station 1518, and the UE 1514 illustrated in FIG. 15 may be similar or identical to the host computer 1416, one of the base stations 1406A, 1406B, 1406C, and one of the UEs 1412, 1414 of FIG. 14, respectively. This is to say, the inner workings of these entities may be as shown in FIG. 15 and independently, the surrounding network topology may be that of FIG. 14.

In FIG. 15, the OTT connection 1516 has been drawn abstractly to illustrate the communication between the host computer 1502 and the UE 1514 via the base station 1518 without explicit reference to any intermediary devices and the precise routing of messages via these devices. The network infrastructure may determine the routing, which may be configured to hide from the UE 1514 or from the service provider operating the host computer 1502, or both. While the OTT connection 1516 is active, the network infrastructure may further take decisions by which it dynamically changes the routing (e.g., on the basis of load balancing consideration or reconfiguration of the network).

The wireless connection 1526 between the UE 1514 and the base station 1518 is in accordance with the teachings of the embodiments described throughout this disclosure. One or more of the various embodiments improve the performance of OTT services provided to the UE 1514 using the OTT connection 1516, in which the wireless connection 1526 forms the last segment.

A measurement procedure may be provided for the purpose of monitoring data rate, latency, and other factors on which the one or more embodiments improve. There may further be an optional network functionality for reconfiguring the OTT connection 1516 between the host computer 1502 and the UE 1514, in response to variations in the measurement results. The measurement procedure and/or the network functionality for reconfiguring the OTT connection 1516 may be implemented in the software 1510 and the hardware 1504 of the host computer 1502 or in the software 1540 and the hardware 1534 of the UE 1514, or both. In some embodiments, sensors (not shown) may be deployed in or in association with communication devices through which the OTT connection 1516 passes; the sensors may participate in the measurement procedure by supplying values of the monitored quantities exemplified above, or supplying values of other physical quantities from which the software 1510, 1540 may compute or estimate the monitored quantities. The reconfiguring of the OTT connection 1516 may include message format, retransmission settings, preferred routing, etc.; the reconfiguring need not affect the base station 1518, and it may be unknown or imperceptible to the base station 1518. Such procedures and functionalities may be known and practiced in the art. In certain embodiments, measurements may involve proprietary UE signaling facilitating the host computer 1502's measurements of throughput, propagation times, latency, and the like. The measurements may be implemented in that the software 1510 and 1540 causes messages to be transmitted, in particular empty or ‘dummy’ messages, using the OTT connection 1516 while it monitors propagation times, errors, etc.

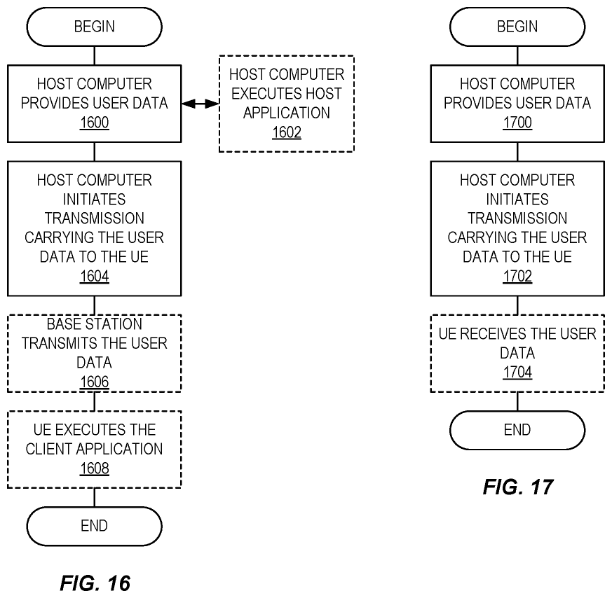

FIG. 16 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 16 will be included in this section. In step 1600, the host computer provides user data. In sub-step 1602 (which may be optional) of step 1600, the host computer provides the user data by executing a host application. In step 1604, the host computer initiates a transmission carrying the user data to the UE. In step 1606 (which may be optional), the base station transmits to the UE the user data which was carried in the transmission that the host computer initiated, in accordance with the teachings of the embodiments described throughout this disclosure. In step 1608 (which may also be optional), the UE executes a client application associated with the host application executed by the host computer.

FIG. 17 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 17 will be included in this section. In step 1700 of the method, the host computer provides user data. In an optional sub-step (not shown) the host computer provides the user data by executing a host application. In step 1702, the host computer initiates a transmission carrying the user data to the UE. The transmission may pass via the base station, in accordance with the teachings of the embodiments described throughout this disclosure. In step 1704 (which may be optional), the UE receives the user data carried in the transmission.

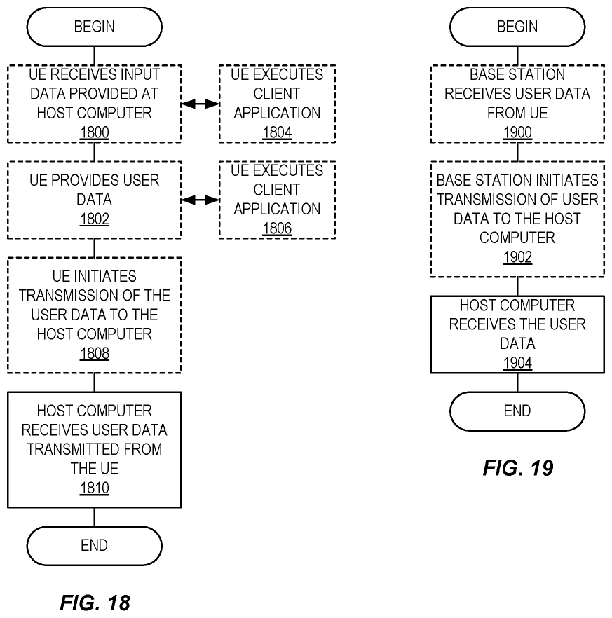

FIG. 18 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 18 will be included in this section. In step 1800 (which may be optional), the UE receives input data provided by the host computer. Additionally or alternatively, in step 1802, the UE provides user data. In sub-step 1804 (which may be optional) of step 1800, the UE provides the user data by executing a client application. In sub-step 1806 (which may be optional) of step 1802, the UE executes a client application which provides the user data in reaction to the received input data provided by the host computer. In providing the user data, the executed client application may further consider user input received from the user. Regardless of the specific manner in which the user data was provided, the UE initiates, in sub-step 1808 (which may be optional), transmission of the user data to the host computer. In step 1810 of the method, the host computer receives the user data transmitted from the UE, in accordance with the teachings of the embodiments described throughout this disclosure.

FIG. 19 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 19 will be included in this section. In step 1900 (which may be optional), in accordance with the teachings of the embodiments described throughout this disclosure, the base station receives user data from the UE. In step 1902 (which may be optional), the base station initiates transmission of the received user data to the host computer. In step 1904 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows.

Embodiment 1: A method performed by a wireless device comprising: performing (604) a CSI omission procedure to omit a deterministic portion of UCI comprised in a CSI report and thereby provide a reduced-size CSI report; and transmitting (606) the reduced-size CSI report.

Embodiment 2: The method of embodiment 1 further comprising: receiving (600) an uplink resource allocation for transmission of the CSI report from a base station; wherein performing (604) the CSI omission procedure comprises performing (604) the CSI omission procedure such that a size of the CSI report is reduced to a size that fits within the uplink resource allocation.

Embodiment 3: The method of embodiment 2 further comprising determining (602) that the size of the CSI report does not fit within the uplink resource allocation, wherein performing (604) the CSI omission procedure comprises performing (604) the CSI omission procedure upon determining that the size of the CSI report does not fit within the uplink resource allocation.

Embodiment 4: The method of any one of embodiments 1 to 3 wherein performing (604) the CSI omission procedure comprises: assigning a certain ordering to UCI parameters or individual bits in UCI parameters in at least a part of UCI comprised in the CSI report; dividing the UCI parameters or the individual bits in the UCI parameters into two or more CSI omission groups based on the certain ordering, the two or more CSI omission groups having associated priority levels; and omitting the UCI parameters or the individual bits in the UCI parameters comprised in at least one of the two or more CSI omission groups having based on their priority levels (e.g., until the size of the CSI report fits within the uplink resource allocation).

Embodiment 5: The method of embodiment 4 wherein the UCI parameters comprise LC coefficients, and assigning the certain ordering to the UCI parameters or individual bits in the UCI parameters in at least a part of the UCI comprises assigning the certain ordering to the LC coefficients, the certain ordering being with respect to layer-index, SD-basis index, and/or FD-basis index.

Embodiment 6: The method of embodiment 4 wherein the UCI parameters comprise LC coefficients and non-zero coefficient bitmaps, and assigning the certain ordering to the UCI parameters or individual bits in the UCI parameters in at least a part of the UCI comprises assigning the certain ordering to the LC coefficients and the non-zero coefficient bitmaps, the certain ordering being with respect to layer-index, SD-basis index, and/or FD-basis index.

Embodiment 7: The method of embodiment 5 or 6 wherein the certain ordering is according to layer-index first, then FD-basis, then SD-basis.

Embodiment 8: The method of embodiment 5 or 6 wherein the certain ordering is according to FD-basis index first, then SD-basis index, then layer-index.

Embodiment 9: The method of embodiment 5 or 6 wherein the certain ordering is according to a permuted order of the FD-basis index.

Embodiment 10: The method of embodiment 9 wherein the permuted order of the FD-basis index prioritizes FD-basis indices close to the zero lag in a modulo sense (e.g., those FD-basis indices come first).

Embodiment 11: The method of any one of embodiments 1 to 10 wherein the number of CSI omission groups is deterministic.

Embodiment 12: The method of any one of embodiments 1 to 10 wherein the number of CSI omission groups can be determined prior to decoding the part of the UCI in which UCI parameters or bits of the UCI parameters are omitted.

Embodiment 13: The method of any one of embodiments 1 to 12 wherein the CSI report is a Rel-16 CSI Type II report.

Embodiment 14: The method of any of the previous embodiments, further comprising: providing user data; and forwarding the user data to a host computer via the transmission to the base station.

Embodiment 15: A method performed by a base station comprising: receiving (606) a reduced-size CSI report from a UE; and decoding (608) the reduced-size CSI report using a CSI omission procedure to determine a portion UCI omitted in the reduced-size CSI report.

Embodiment 16: The method of embodiment 15 further comprising transmitting (600), to the UE, an uplink resource allocation for transmission of the CSI report.

Embodiment 17: The method of any one of embodiments 15 to 16 wherein the CSI omission procedure comprises: assigning a certain ordering to UCI parameters or individual bits in UCI parameters in at least a part of UCI comprised in the CSI report; dividing the UCI parameters or the individual bits in the UCI parameters into two or more CSI omission groups based on the certain ordering, the two or more CSI omission groups having associated priority levels; and omitting the UCI parameters or the individual bits in the UCI parameters comprised in at least one of the two or more CSI omission groups having based on their priority levels (e.g., until the size of the CSI report fits within the uplink resource allocation).

Embodiment 18: The method of embodiment 17 wherein the UCI parameters comprise LC coefficients, and assigning the certain ordering to the UCI parameters or individual bits in the UCI parameters in at least a part of the UCI comprises assigning the certain ordering to the LC coefficients, the certain ordering being with respect to layer-index, SD-basis index, and/or FD-basis index.

Embodiment 19: The method of embodiment 18 wherein the UCI parameters comprise LC coefficients and non-zero coefficient bitmaps, and assigning the certain ordering to the UCI parameters or individual bits in the UCI parameters in at least a part of the UCI comprises assigning the certain ordering to the LC coefficients and the non-zero coefficient bitmaps, the certain ordering being with respect to layer-index, SD-basis index, and/or FD-basis index.

Embodiment 20: The method of embodiment 18 or 19 wherein the certain ordering is according to layer-index first, then FD-basis, then SD-basis.

Embodiment 21: The method of embodiment 18 or 19 wherein the certain ordering is according to FD-basis index first, then SD-basis index, then layer-index.

Embodiment 22: The method of embodiment 18 or 19 wherein the certain ordering is according to a permuted order of the FD-basis index.

Embodiment 23: The method of embodiment 22 wherein the permuted order of the FD-basis index prioritizes FD-basis indices close to the zero lag in a modulo sense (e.g., those FD-basis indices come first).

Embodiment 24: The method of any one of embodiments 15 to 23 wherein the number of CSI omission groups is deterministic.

Embodiment 25: The method of any one of embodiments 15 to 23 wherein the number of CSI omission groups can be determined prior to decoding the part of the UCI in which UCI parameters or bits of the UCI parameters are omitted.

Embodiment 26: The method of any one of embodiments 1 to 12 wherein the CSI report is a Rel-16 CSI Type II report.

Embodiment 27: The method of any of the previous embodiments, further comprising: obtaining user data; and forwarding the user data to a host computer or a wireless device.

Embodiment 28: A wireless device comprising: processing circuitry configured to perform any of the steps of any of embodiments 1 to 14; and power supply circuitry configured to supply power to the wireless device.

Embodiment 29: A base station comprising: processing circuitry configured to perform any of the steps of any of embodiments 15 to 27; and power supply circuitry configured to supply power to the base station.

Embodiment 30: A User Equipment, UE, comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of embodiments 1 to 14; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 31: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of embodiments 15 to 27.

Embodiment 32: The communication system of the previous embodiment further including the base station.

Embodiment 33: The communication system of the previous 2 embodiments, further including the UE, wherein the UE is configured to communicate with the base station.

Embodiment 34: The communication system of the previous 3 embodiments, wherein: the processing circuitry of the host computer is configured to execute a host application, thereby providing the user data; and the UE comprises processing circuitry configured to execute a client application associated with the host application.

Embodiment 35: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of embodiments 15 to 27.

Embodiment 36: The method of the previous embodiment, further comprising, at the base station, transmitting the user data.

Embodiment 37: The method of the previous 2 embodiments, wherein the user data is provided at the host computer by executing a host application, the method further comprising, at the UE, executing a client application associated with the host application.

Embodiment 38: A User Equipment, UE, configured to communicate with a base station, the UE comprising a radio interface and processing circuitry configured to perform the method of the previous 3 embodiments.

Embodiment 39: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of embodiments 1 to 14.

Embodiment 40: The communication system of the previous embodiment, wherein the cellular network further includes a base station configured to communicate with the UE.

Embodiment 41: The communication system of the previous 2 embodiments, wherein: the processing circuitry of the host computer is configured to execute a host application, thereby providing the user data; and the UE's processing circuitry is configured to execute a client application associated with the host application.

Embodiment 42: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of embodiments 1 to 14.

Embodiment 43: The method of the previous embodiment, further comprising at the UE, receiving the user data from the base station.

Embodiment 44: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of embodiments 1 to 14.

Embodiment 45: The communication system of the previous embodiment, further including the UE.

Embodiment 46: The communication system of the previous 2 embodiments, further including the base station, wherein the base station comprises a radio interface configured to communicate with the UE and a communication interface configured to forward to the host computer the user data carried by a transmission from the UE to the base station.

Embodiment 47: The communication system of the previous 3 embodiments, wherein: the processing circuitry of the host computer is configured to execute a host application; and the UE's processing circuitry is configured to execute a client application associated with the host application, thereby providing the user data.

Embodiment 48: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 49: A method implemented in a communication system including a host computer, a base station, and a User Equipment, UE, the method comprising: at the host computer, receiving user data transmitted to the base station from the UE, wherein the UE performs any of the steps of any of embodiments 1 to 14.

Embodiment 50: The method of the previous embodiment, further comprising, at the UE, providing the user data to the base station.

Embodiment 51: The method of the previous 2 embodiments, further comprising: at the UE, executing a client application, thereby providing the user data to be transmitted; and at the host computer, executing a host application associated with the client application.

Embodiment 52: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 53: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of embodiments 15 to 27.

Embodiment 54: The communication system of the previous embodiment further including the base station.

Embodiment 55: The communication system of the previous 2 embodiments, further including the UE, wherein the UE is configured to communicate with the base station.

Embodiment 56: The communication system of the previous 3 embodiments, wherein: the processing circuitry of the host computer is configured to execute a host application; and the UE is configured to execute a client application associated with the host application, thereby providing the user data to be received by the host computer.

Embodiment 57: A method implemented in a communication system including a host computer, a base station, and a User Equipment, UE, the method comprising: at the host computer, receiving, from the base station, user data originating from a transmission which the base station has received from the UE, wherein the UE performs any of the steps of any of embodiments 1 to 14.

Embodiment 58: The method of the previous embodiment, further comprising at the base station, receiving the user data from the UE.

Embodiment 59: The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
16PSK 16-Phase Shift Keying
2D Two-Dimensional
3GPP Third Generation Partnership Project
5G Fifth Generation
5GC Fifth Generation Core
5GS Fifth Generation System
8PSK 8-Phase Shift Keying
AMF Access and Mobility Function
AP Access Point
ASIC Application Specific Integrated Circuit
AUSF Authentication Server Function
BWP Bandwidth Part
CPU Central Processing Unit
CQI Channel Quality Indicator
CRI Channel State Information Reference Signal Resource Indicator
CSI Channel State Information
CSI-RS Channel State Information Reference Signal
dB Decibel
DFT Discrete Fourier Transform
DSP Digital Signal Processor
eNB Enhanced or Evolved Node B
FD Frequency Domain
FPGA Field Programmable Gate Array
gNB New Radio Base Station
HSS Home Subscriber Server
IMR Interference Measurement Resource
LC Linear Combination
LTE Long Term Evolution
MCS Modulation and Coding Scheme
MIMO Multiple Input Multiple Output
MME Mobility Management Entity
MTC Machine Type Communication
MU-MIMO Multi-User Multiple Input Multiple Output
NEF Network Exposure Function
NR New Radio
NRF Network Function Repository Function
NSSF Network Slice Selection Function
NZ Non-Zero
NZCBₗ, Non-Zero Coefficient Bitmaps per layer
NZP Non-Zero Power
OFDM Orthogonal Frequency Division Multiplexing
OTT Over-the-Top
PCF Policy Control Function
P-GW Packet Data Network Gateway
PMI Precoder Matrix Indicator
PRB Physical Resource Block
PUSCH Physical Uplink Shared Channel
QPSK Quadrature Phase Shift Keying
RAM Random Access Memory
RAN Radio Access Network
RB Resource Block
RE Resource Element
RI Rank Indicator
ROM Read Only Memory
RRC Radio Resource Control
RRH Remote Radio Head
SCEF Service Capability Exposure Function
SCI Strongest Coefficient Index
SCIₗ Strongest Coefficient Index per layer
SD Spatial Domain
SINR Signal-to-Interference plus Noise Ratio
SMF Session Management Function
TFRE Time/Frequency Resource Element
TS Technical Specification
UCI Uplink Control Information
UDM Unified Data Management
UE User Equipment
ULA Uniform Linear Array
UPA Uniform Planar Array
UPF User Plane Function

Those skilled in the art will recognize improvements and modifications to the embodiments of the present disclosure. All such improvements and modifications are considered within the scope of the concepts disclosed herein.

1. A method performed by a wireless device for Channel State Information, CSI, reporting in a cellular communications system, the method comprising:
performing a CSI omission procedure to omit a deterministic portion of Uplink Control Information, UCI, for a CSI report and thereby provide a reduced-size CSI report, wherein performing the CSI omission procedure comprises:
dividing a plurality of Linear Combination, LC, coefficients into two or more CSI omission groups having associated priority levels by:
assigning a certain ordering to the plurality of LC coefficients; and
dividing the plurality of LC coefficients into two or more CSI omission groups based on the certain ordering; and
based on the priority levels of the two or more CSI omission groups, omitting LC coefficients comprised in at least one of the two or more CSI omission groups from the reduced-size CSI report; and
transmitting the reduced-size CSI report.

2. The method of claim 1 wherein the plurality of LC coefficients are phase/amplitude coefficients c_{i,m}^{(l)} for each value of a layer-index l for each value of a spatial domain basis, SD-basis, index i for each value of a frequency domain basis, FD-basis, index m where:
l=0, 1, . . . , v−1 where v is a number of layers of one or more precoders indicated by the CSI report;
i=0, 1, . . . , 2L−1 where L is a number of spatial domain basis vectors for the one or more precoders for each of two polarizations; and
m=0, 1, . . . , M−1 where M is a nominal number of frequency domain components for the one or more precoders.

3. The method of claim 2 wherein the CSI report is for codebook based precoding based on a codebook having a codebook structure that utilizes both frequency domain compression and spatial domain compression, wherein, for each layer l, the codebook structure is according to:
$${W}^{( l )} = [ {w}^{( l ) ( 0 )} … {w}^{( l ) ( {N}_{3} - 1 )} ] = {W}_{1}^{( l )} {{\tilde{W}}_{2}^{( l )} ( {W}_{f}^{( l )} )}^{H} \qquad ( l )$$
where:
W^{(l)} is a size—P×N₃ matrix that defines precoder vectors for the codebook for all FD units or subbands for the layer l,
P=2N₁N₂ is the number of SD dimensions,
N₁ is a number of antennas in a first dimension of a 2D antenna array of the base station,
N₂ is a number of antennas in a second dimension of the 2D antenna array of the base station,
N₃=N_{SB}×R is the number of FD dimensions where R={1, 2} and is a Precoding Matrix Indicator, PMI, subband size indicator,
$${W}_{1}^{( l )} = [ \begin{matrix}{v}_{0} {v}_{1 } … {v}_{L - 1} & 0 \\ 0 & {v}_{0} {v}_{1 } … {v}_{L - 1}\end{matrix} ]$$
where {vᵢ}ᵢ₌₀^{L-1} are N₁N₂×1 orthogonal Discrete Fourier Transform, DFT, vectors,
$${\tilde{W}}_{2}^{( l )} = [ \begin{matrix}{c}_{0 , 0}^{( l )} & … & {c}_{0 , M - 1}^{( l )} \\ ⋮ & ⋱ & ⋮ \\ {c}_{2 L - 1 , 0}^{( l )} & … & {c}_{2 L - 1 , M - 1}^{( l )}\end{matrix} ] ,$$
and
W_{f}^{(l)}=[fₖ_{₀} fₖ_{₁} . . . fₖ_{_{M-1}}], where {fₖ_{ₘ}}ₘ₌₀^{M-1} are M size-N₃×1 orthogonal DFT vectors.

4. (canceled)

5. The method of claim 2 wherein assigning the certain ordering to the plurality of LC coefficients comprises assigning the certain ordering to the plurality of LC coefficients with respect to: the layer-index l, SD-basis index i, FD-basis index m, or any combination of two or more of (a)-(c).

6. The method of claim 2 wherein assigning the certain ordering to the plurality of LC coefficients comprises assigning the certain ordering to the plurality of LC coefficients according to the FD-basis index m first, then the SD-basis index i, then layer-index l.

7. The method of claim 6 wherein the certain ordering is according to a permuted order of the FD-basis index m.

8. The method of claim 7 wherein the permuted order of the FD-basis index m is such that FD-basis indices close to a zero lag in a modulo sense come first in the certain ordering.

9. The method of claim 5 wherein the UCI further comprises non-zero coefficient bitmaps, and performing the CSI omission procedure further comprises:
assigning the same certain ordering to the non-zero coefficient bitmaps; and
omitting bits from the non-zero coefficient bitmaps according to the same certain ordering.

10. The method of claim 9 wherein the number of omitted bits from the non-zero coefficient bitmaps is equal to the number of omitted LC coefficients.

11. The method of claim 2 wherein assigning the certain ordering to the plurality of LC coefficients comprises assigning the certain ordering to the plurality of LC coefficients according to the layer-index l first, then the FD-basis m, and then SD-basis i.

12. The method of claim 11 wherein the certain ordering is according to a permuted order of the FD-basis index m.

13. The method of claim 2 wherein:
$${c}_{i , m}^{( l )} = {p}_{ref} ( ⌊ \frac{i}{L} ⌋ ) \times p ( i , m ) \times φ ( i , m )$$
where:
$${p}_{ref} ( ⌊ \frac{i}{L} ⌋ )$$
is a reference amplitude,
p(i,m) is an amplitude component of the LC coefficient c_{i,m}^{(l)} relative to the reference amplitude
$${p}_{ref} ( ⌊ \frac{i}{L} ⌋ ) ,$$
and
ϕ(i,m) is a phase component.

14. The method of claim 1 further comprising:
receiving an uplink resource allocation for transmission of the CSI report from a base station;
wherein performing the CSI omission procedure comprises performing the CSI omission procedure such that a size of the reduced-size CSI report is fits within the uplink resource allocation.

15. The method of claim 14 further comprising determining that the size of the CSI report does not fit within the uplink resource allocation, wherein performing the CSI omission procedure comprises performing the CSI omission procedure upon determining that the size of the CSI report does not fit within the uplink resource allocation.

16. The method of claim 1 wherein the UCI comprises:
a first UCI part that comprises a Rank Indicator, RI, and a number of non-zero coefficients summed across all layers; and
a second UCI part that comprises:
a SD-basis indication;
a FD-basis indication per layer;
SD oversampling factors;
non-zero coefficient bitmaps per layer;
a strongest coefficient indicator per layer;
the plurality of LC coefficients comprising LC coefficients for each layer; and
a reference amplitude for a weaker polarization of two or more polarizations for the CSI report.

17. The method of claim 1 wherein the CSI report is for codebook based precoding based on a codebook having a codebook structure that utilizes both frequency domain compression and spatial domain compression.

18. A wireless device for Channel State Information, CSI, reporting for a cellular communications system, the wireless device adapted to:
perform a CSI omission procedure to omit a deterministic portion of Uplink Control Information, UCI, for a CSI report and thereby provide a reduced-size CSI report, wherein in order to perform the CSI omission procedure, the wireless device is further adapted to:
divide a plurality of Linear Combination, LC, coefficients into two or more CSI omission groups having associated priority levels by being adapted to:
assign a certain ordering to the plurality of LC coefficients; and
divide the plurality of LC coefficients into two or more CSI omission groups based on the certain ordering; and
based on the priority levels of the two or more CSI omission groups, omit LC coefficients comprised in at least one of the two or more CSI omission groups from the reduced-size CSI report; and
transmit the reduced-size CSI report.

19. (canceled)

20. A wireless device for Channel State Information, CSI, reporting for a cellular communications system, the wireless device comprising:
one or more transmitters;
one or more receivers; and
processing circuitry associated with the one or more transmitters and the one or more receivers, the processing circuitry configured to cause the wireless device to:
perform a CSI omission procedure to omit a deterministic portion of Uplink Control Information, UCI, for a CSI report and thereby provide a reduced-size CSI report, wherein in order to perform the CSI omission procedure, the processing circuitry is further configured to cause the wireless device to:
divide a plurality of Linear Combination, LC, coefficients into two or more CSI omission groups having associated priority levels by being configured to cause the wireless device to:
assign a certain ordering to the plurality of LC coefficients; and
divide the plurality of LC coefficients into two or more CSI omission groups based on the certain ordering; and
based on the priority levels of the two or more CSI omission groups, omit LC coefficients comprised in at least one of the two or more CSI omission groups from the reduced-size CSI report; and
transmit the reduced-size CSI report.

21. A method performed by a base station for Channel State Information, CSI, reporting in a cellular communications system, the method comprising:
receiving a reduced-size CSI report from a wireless device, the reduced-size CSI report being a CSI report for which a portion of Uplink Control Information, UCI, is omitted based on a CSI omission procedure; and
decoding the reduced-size CSI report using the CSI omission procedure to determine the portion of the UCI that has been omitted, wherein decoding the reduced-size CSI report using the CSI omission procedure to determine the portion of the UCI that has been omitted comprises:
dividing a plurality of Linear Combination, LC, coefficients into two or more CSI omission groups having associated priority levels by:
assigning a certain ordering to the plurality of LC coefficients; and
dividing the plurality of LC coefficients into two or more CSI omission groups based on the certain ordering; and
based on the priority levels of the two or more CSI omission groups, determining that LC coefficients comprised in at least one of the two or more CSI omission groups are omitted from the reduced-size CSI report.

22. The method of claim 21 wherein the plurality of LC coefficients are phase/amplitude coefficients c_{i,m}^{(l)} for each value of a layer-index l for each value of a spatial domain basis, SD-basis, index i for each value of a frequency domain basis, FD-basis, index m where:
l=0, 1, . . . , v−1 where v is a number of layers of one or more precoders indicated by the CSI report;
i=0, 1, . . . , 2L−1 where L is a number of spatial domain basis vectors for the one or more precoders for each of two polarizations; and
m=0, 1, . . . , M−1 where M is a nominal number of frequency domain components for the one or more precoders.

23. The method of claim 22 wherein the reduced-size CSI report is for codebook based precoding based on a codebook having a codebook structure that utilizes both frequency domain compression and spatial domain compression, wherein, for each layer l, the codebook structure is according to:
$${W}^{( l )} = [ {w}^{( l ) ( 0 )} … {w}^{( l ) ( {N}_{3} - 1 )} ] = {W}_{1}^{( l )} {{\tilde{W}}_{2}^{( l )} ( {W}_{f}^{( l )} )}^{H} \qquad ( l )$$
where:
W^{(l)} is a size—P×N₃ matrix that defines precoder vectors for the codebook for all FD units or subbands for the layer l,
P=2N₁N₂ is the number of SD dimensions,
N₁ is a number of antennas in a first dimension of a 2D antenna array of the base station,
N₂ is a number of antennas in a second dimension of the 2D antenna array of the base station,
N₃=N_{SB}×R is the number of FD dimensions where R={1, 2} and is a Precoding Matrix Indicator, PMI, subband size indicator,
$${W}_{1}^{( l )} = [ \begin{matrix}{v}_{0} {v}_{1 } … {v}_{L - 1} & 0 \\ 0 & {v}_{0} {v}_{1 } … {v}_{L - 1}\end{matrix} ]$$
where {vᵢ}ᵢ₌₀^{L-1} are N₁N₂×1 orthogonal Discrete Fourier Transform, DFT, vectors,
$${\tilde{W}}_{2}^{( l )} = [ \begin{matrix}{c}_{0 , 0}^{( l )} & … & {c}_{0 , M - 1}^{( l )} \\ ⋮ & ⋱ & ⋮ \\ {c}_{2 L - 1 , 0}^{( l )} & … & {c}_{2 L - 1 , M - 1}^{( l )}\end{matrix} ] ,$$
and
W_{f}^{(l)}=[fₖ_{₀} fₖ_{₁} . . . fₖ_{_{M-1}}], where {fₖ_{ₘ}}ₘ₌₀^{M-1} are M size-N₃×1 orthogonal DFT vectors.

24. (canceled)

25. The method of claim 22 wherein assigning the certain ordering to the plurality of LC coefficients comprises assigning the certain ordering to the plurality of LC coefficients with respect to: the layer-index l, SD-basis index i, FD-basis index m, or any combination of two or more of (a)-(c).

26. The method of claim 22 wherein assigning the certain ordering to the plurality of LC coefficients comprises assigning the certain ordering to the plurality of LC coefficients according to the FD-basis index m first, then the SD-basis index i, then layer-index l.

27. The method of claim 26 wherein the certain ordering is according to a permuted order of the FD-basis index m.

28-30. (canceled)

31. A base station for Channel State Information, CSI, reporting for a cellular communications system, the base station adapted to:
receive a reduced-size CSI report from a wireless device, the reduced-size CSI report being a CSI report for which a portion of Uplink Control Information, UCI, is omitted based on a CSI omission procedure; and
decode the reduced-size CSI report using the CSI omission procedure to determine the portion of the UCI that has been omitted, wherein in order to decode the reduced-size CSI report using the CSI omission procedure to determine the portion of the UCI that has been omitted the CSI omission procedure, the base station is further adapted to:
divide a plurality of Linear Combination, LC, coefficients into two or more CSI omission groups having associated priority levels by being adapted to:
assign a certain ordering to the plurality of LC coefficients; and
divide the plurality of LC coefficients into two or more CSI omission groups based on the certain ordering; and
based on the priority levels of the two or more CSI omission groups, determine that LC coefficients comprised in at least one of the two or more CSI omission groups are omitted from the reduced-size CSI report.

32. (canceled)

33. A base station for Channel State Information, CSI, reporting for a cellular communications system, the base station comprising processing circuitry configured to cause the base station to:
receive a reduced-size CSI report from a wireless device, the reduced-size CSI report being a CSI report for which a portion of Uplink Control Information, UCI, is omitted based on a CSI omission procedure; and
decode the reduced-size CSI report using the CSI omission procedure to determine the portion of the UCI that has been omitted, wherein in order to decode the reduced-size CSI report using the CSI omission procedure to determine the portion of the UCI that has been omitted the CSI omission procedure, the processing circuitry is further configured to cause the base station to:
divide a plurality of Linear Combination, LC, coefficients into two or more CSI omission groups having associated priority levels by being configured to:
assign a certain ordering to the plurality of LC coefficients; and
divide the plurality of LC coefficients into two or more CSI omission groups based on the certain ordering; and
based on the priority levels of the two or more CSI omission groups, determine that LC coefficients comprised in at least one of the two or more CSI omission groups are omitted from the reduced-size CSI report.
